(19) United States
(12) Patent Application Publication
(10) Pub. No.: US 2025/0071800 A1
(43) Pub. Date: Feb. 27, 2025

(54) COMMUNICATION DEVICE IN COMMUNICATION SYSTEM AND METHOD PERFORMED BY THE SAME

(71) Applicant: SAMSUNG ELECTRONICS CO., LTD., Suwon-si, Gyeonggi-do (KR)

(72) Inventors: Miao ZHOU, Beijing (CN); Min WU, Beijing (CN); Feifei SUN, Beijing (CN)

(21) Appl. No.: 18/727,059

(22) PCT Filed: Jan. 6, 2023
(86) PCT No.: PCT/KR2023/000269

§ 371 Date: Jul. 5, 2024

(30) Foreign Application Priority Data
Jan. 7, 2022 (CN) 202210016692.3
Feb. 11, 2022 (CN) 202210130338.3

(51) Int. Cl. H04W 72/563; H04L 1/1829; H04W 72/25

(52) U.S. Cl. CPC H04W 72/563; H04L 1/1864; H04W 72/25

(57) ABSTRACT

The disclosure provides a method performed by a communication device in a communication system, comprising: receiving multiple sidelink control information (SCI) from other communication devices; when the multiple SCI indicate the same or partially overlapping resource, based on at least one of information about relationship between the communication device and the multiple SCI, received power information related to the multiple SCI, and information about priorities indicated by the multiple SCI, determining whether a conflict occurs on resources indicated by the multiple SCI.

### TECHNICAL FIELD

The disclosure relates to a technical field of a wireless communication, in particular to a method for determining resources for sidelink (SL) transmission in SL communication system.

### BACKGROUND ART

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6th generation (6G) mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multi input multi output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies such as industrial internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting Augmented Reality (AR), Virtual Reality (VR), Mixed Reality (MR) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using Orbital Angular Momentum (OAM), and Reconfigurable Intelligent Surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The disclosure provides a method for determining sidelink resources in a sidelink communication system.

### Solution to Problem

The present disclosure has been made to address the above-mentioned problems and disadvantages, and to provide at least the advantages described below.

According to an aspect of the present disclosure, there is provided a method performed by a communication device in a communication system, which includes receiving multiple sidelink control information SCI from other communication devices; when the multiple SCI indicate the same or partially overlapping resource, based on at least one of information about relationship between the communication device and the multiple SCI, received power information related to the multiple SCI, and information about priorities indicated by the multiple SCI, determining whether a conflict occurs on resources indicated by the multiple SCI.

According to the embodiment of the present disclosure, it further includes: sorting the multiple SCI; and in order of the sorted multiple SCI, determining whether the same or partially overlapping resource is indicated and/or whether the conflict occurs on the resources indicated by the multiple SCI.

According to an embodiment of the present disclosure, wherein determining whether the multiple SCI indicate the same or partially overlapping resource comprises at least one of the following methods: for resources indicated by any two SCI in the multiple SCI, determining whether the resources indicated by the any two SCI are the same or partially overlaps; for resource indicated by any one SCI in the multiple SCI, determining whether the resource indicated by the any one SCI is the same as or partially overlaps with the resources indicated by at least one of all remaining SCI; and for any one resource in a predetermined resource set, determining whether there are at least two resources including the any one resource among the resources indicated by the multiple SCI.

According to an embodiment of the present disclosure, wherein determining whether the resources indicated by the any two SCI are the same or partially overlaps further comprises: selecting the any two SCI in a configured or predetermined order, wherein determining whether the resource indicated by the any one SCI is the same as or partially overlaps with the resources indicated by the at least one of the all remaining SCI further comprises: selecting the any one SCI in a configured or predetermined order, wherein the order is based on at least one of the following: priority indicated by the SCI, reference signal received power of the SCI, and information related to the same or partially overlapping resource in the time domain and/or the frequency domain.

According to an embodiment of the present disclosure, wherein the predetermined resource set includes at least one of a time domain resource range, a frequency domain resource range, a resource set, and a resource pool, wherein at least one of the time domain resource range, the frequency domain resource range, and the resource set is determined based on the resource pool and/or the sidelink reception of the communication device, wherein the sidelink reception of the communication device includes resources or a resource set indicated in the SCI received by the communication device on the sidelink.

According to the embodiments of the present disclosure, it further includes: in case that it is determined that the conflict occurs, determining whether to send a conflict indication to other SCI in a set of SCI in which the conflicts occur except the SCI with the highest priority, and/or determining whether to send a conflict indication to a communication device, from which other SCI except the SCI with the highest priority in a set of SCI comes, the set is a set of SCI in which the conflicts occur.

According to an embodiment of the present disclosure, it further includes: after determining that the conflict indication is sent to the SCI and/or the communication device, when the communication device continues to determine whether the conflict occurs on the resources indicated by the multiple SCI, removing the determined SCI to which the conflict indication is sent from the received multiple SCI, and/or removing the determined communication device to which the conflict indication is sent from the communication devices from which the multiple SCI come, and/or removing the resource on which the conflict is determined to occur from the resources indicated by the multiple SCI.

According to an embodiment of the present disclosure, wherein sorting the SCI comprises: sorting the multiple SCI based on at least one of the information about the relationship between the communication device and the multiple SCI, the received power information related to the multiple SCI, and the information about priorities indicated by the multiple SCI.

According to an embodiment of the present disclosure, it further comprises: when the conflicts occur on the resources indicated by the multiple SCI, determining whether to send a conflict indication and/or a resources corresponding to the conflict indication based on at least one of information about relationship between SCI related to the conflict and the communication device, information about whether data transmitted on the resource indicated by the SCI related to the conflict is successfully received by the communication device, and hybrid automatic repeat request (HARQ) information about data associated with the SCI related to the conflict.

According to the embodiment of the present disclosure, wherein determining whether the conflict occurs on the resources indicated by the multiple SCI is further based on at least one of the following: whether the multiple SCI indicate the same or partially overlapping resources, whether HARQ information of data transmission corresponding to the multiple SCI is ACK, and whether data associated with the multiple SCI is successfully received.

According to an aspect of the present disclosure, there is provided a method performed by a communication device in a communication system, which includes: enabling feedback and enabling inter-UE coordination IUC indicating a conflict; and transmitting feedback information and conflict indication information on a feedback channel.

According to an embodiment of the present disclosure, it further includes: when both the feedback information and the conflict indication information are transmitted on the feedback channel, using at least one of the following methods: multiplexing the feedback information and the conflict indication information; bundling the feedback information and the conflict indication information; jointly coding the feedback information and the conflict indication information.

According to the embodiment of the present disclosure, it further comprises: when the feedback information and the conflict indication information are multiplexed, multiplexing the feedback information and the conflict indication information in the same feedback channel, wherein information of a+b bits is indicated in the feedback channel, a and b are any positive integer, wherein a bits are used for the feedback information, b bit are used for the conflict indication information, wherein b includes at least one of the following: the maximum number of resources that can be indicated in the sidelink control information SCI, the number of resources actually indicated in the SCI, the maximum number of resources that can be indicated in the SCI-p₁, and the number of resources actually indicated in the SCI-p₂, where p₁ and p₂ are positive integers, wherein the SCI includes SCI corresponding to the feedback information and/or the conflict indication information.

According to an embodiment of the present disclosure, it further comprises: when the feedback information and the conflict indication information are bundled, bundling the feedback information and the conflict indication information in the same feedback channel, wherein 1-bit information is indicated in the feedback channel, and the 1-bit information is used to indicate two states, the two states include a first state and a second state, and the first state indicates a state including at least one of the four states: positive feedback and presence of a conflict, positive feedback and absence of a conflict, negative feedback and presence of a conflict, negative feedback and absence of a conflict, and the second state indicates at least one of the fourth state except the first state.

According to the embodiment of the present disclosure, it further comprises: when the feedback information and the conflict indication information are jointly encoded, jointly encoding the feedback information and the conflict indication information in the same feedback channel, where information of log₂(c*d) bits is indicated in the feedback channel, and c and d can be any positive integer, where c is the number of states of the feedback information and d is the number of states of the conflict indication information.

According to an aspect of the present disclosure, there is provided a method performed by a communication device in a communication system, which includes: determining signaling for carrying inter-UE coordination information (IUCI); sending the IUCI based on the determined signaling.

According to an embodiment of the present disclosure, wherein determining the signaling for carrying the IUCI comprises: selecting the signaling for carrying the IUCI based on at least one of latency of the IUCI, channel busy ratio(CBR), service priority, and distance.

According to an embodiment of the present disclosure, wherein determining the signaling for carrying the IUCI includes: selecting the higher layer signaling and the physical layer signaling to carry the IUCI; wherein based on the determined signaling, sending the IUCI includes: carrying different parts of the IUCI in the higher layer signaling and the physical layer signaling based on the type of the IUCI and/or the latency of the IUCI.

According to the embodiment of the present disclosure, wherein the time domain position of the resource indicated by the IUCI is represented by the time domain reference point and the time domain offset of the resource, or by the time domain reference point and the time domain resource indicator value TRIV.

According to the embodiment of the present disclosure, wherein the time domain reference point is at least one of the following: the time domain reference point explicitly indicated in the higher layer signaling when the higher layer signaling is selected to carry the IUCI; a time point when sending the physical layer signaling when the physical layer signaling is selected to carry the IUCI; for a retransmission of the IUCI, the time domain reference point reuses the time domain reference point of the first transmission; for a retransmission of the IUCI, the time domain reference point is determined based on the retransmission at this time.

According to an aspect of the present disclosure, there is provided a communication device including:
a transceiver configured to receive and transmit signals; and
a processor configured to control the communication device to perform the method according to any of the above embodiments.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates an example wireless network according to an embodiment of the present disclosure;

FIG. 2A illustrates an example wireless transmitting path according to embodiments of the present disclosure;

FIG. 2B illustrates an example wireless receiving path according to embodiments of the present disclosure;

FIG. 3A illustrates an example user equipment according to an embodiment of the present disclosure;

FIG. 3B illustrates an example base station according to an embodiment of the present disclosure;

FIG. 4 is a schematic diagram of a communication scenario according to an embodiment of the present disclosure;

FIG. 5 is a flowchart according to embodiment 1 of the present disclosure;

FIG. 6 is a flowchart according to embodiment 2 of the present disclosure; and

FIG. 7 is a flowchart according to embodiment 3 of the present disclosure.

### MODE FOR THE INVENTION

The following description with reference to the drawings is provided to facilitate a comprehensive understanding of various embodiments of the present disclosure defined by the claims and their equivalents. This description includes various specific details to facilitate understanding but should only be considered as exemplary. Therefore, those skilled in the art will recognize that various changes and modifications can be made to the various embodiments described herein without departing from the scope and spirit of the present disclosure. In addition, for the sake of clarity and conciseness, the description of well-known functions and structures may be omitted.

Terms and expressions used in the following specification and claims are not limited to their dictionary meanings, but are only used by the inventors to enable a clear and consistent understanding of the present disclosure. Therefore, it should be obvious to those skilled in the art that the following descriptions of various embodiments of the present disclosure are provided only for the purpose of illustration and not for the purpose of limiting the present disclosure as defined by the appended claims and their equivalents.

It should be understood that singular forms of “a”, “an” and “the” include plural referents, unless the context clearly indicates otherwise. Thus, for example, references to “component surface” include references to one or more such surfaces.

The term “including” or “may include” refers to the existence of the corresponding disclosed functions, operations or components that can be used in various embodiments of the present disclosure, rather than limiting the existence of one or more additional functions, operations or features. In addition, the term “including” or “having” can be interpreted to indicate certain features, numbers, steps, operations, constituent elements, components or combinations thereof, but should not be interpreted to exclude the possibility of the existence of one or more other features, numbers, steps, operations, constituent elements, components or combinations thereof.

The term “or” used in various embodiments of the present disclosure includes any listed terms and all combinations thereof. For example, “A or B” may include A, B, or both A and B.

Unless otherwise defined, all terms (including technical terms or scientific terms) used in this disclosure have the same meanings as understood by those skilled in the art as described in this disclosure. Common terms as defined in dictionaries are interpreted to have meanings consistent with the context in relevant technical fields, and they should not be interpreted idealized or excessively formally, unless explicitly defined as such in this disclosure.

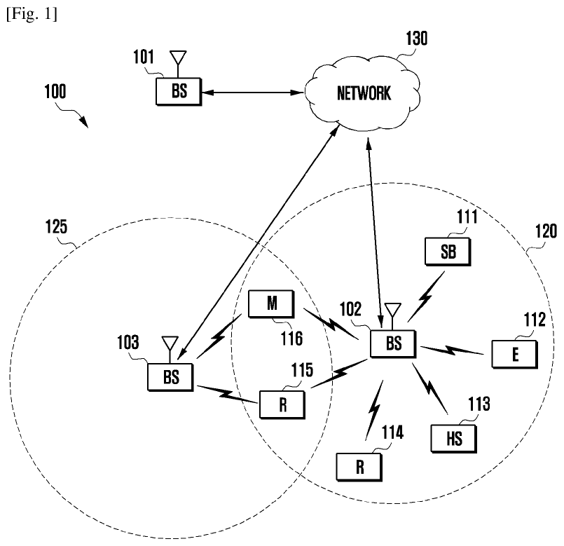

FIG. 1 illustrates an example wireless network 100 according to various embodiments of the present disclosure. The embodiment of the wireless network 100 shown in FIG. 1 is for illustration only. Other embodiments of the wireless network 100 can be used without departing from the scope of the present disclosure.

The wireless network 100 includes a gNodeB (gNB) 101, a gNB 102, and a gNB 103. gNB 101 communicates with gNB 102 and gNB 103. gNB 101 also communicates with at least one network 130, such as the Internet, a private IP network, or other data networks.

Depending on a type of the network, other well-known terms such as “base station” or “access point” can be used instead of “gNodeB” or “gNB”. For convenience, the terms “gNodeB” and “gNB” are used in this patent document to refer to network infrastructure components that provide wireless access for remote terminals. And, depending on the type of the network, other well-known terms such as “mobile station”, “user station”, “remote terminal”, “wireless terminal” or “user apparatus” can be used instead of “user equipment” or “UE”. For convenience, the terms “user equipment” and “UE” are used in this patent document to refer to remote wireless devices that wirelessly access the gNB, no matter whether the UE is a mobile device (such as a mobile phone or a smart phone) or a fixed device (such as a desktop computer or a vending machine).

gNB 102 provides wireless broadband access to the network 130 for a first plurality of User Equipments (UEs) within a coverage area 120 of gNB 102. The first plurality of UEs include a UE 111, which may be located in a Small Business (SB); a UE 112, which may be located in an enterprise (E); a UE 113, which may be located in a WiFi Hotspot (HS); a UE 114, which may be located in a first residence (R); a UE 115, which may be located in a second residence (R); a UE 116, which may be a mobile device (M), such as a cellular phone, a wireless laptop computer, a wireless PDA, etc. GNB 103 provides wireless broadband access to network 130 for a second plurality of UEs within a coverage area 125 of gNB 103. The second plurality of UEs include a UE 115 and a UE 116. In some embodiments, one or more of gNBs 101-103 can communicate with each other and with UEs 111-116 using 5G, Long Term Evolution (LTE), LTE-A, WiMAX or other advanced wireless communication technologies.

The dashed lines show approximate ranges of the coverage areas 120 and 125, and the ranges are shown as approximate circles merely for illustration and explanation purposes. It should be clearly understood that the coverage areas associated with the gNBs, such as the coverage areas 120 and 125, may have other shapes, including irregular shapes, depending on configurations of the gNBs and changes in the radio environment associated with natural obstacles and man-made obstacles.

As will be described in more detail below, one or more of gNB 101, gNB 102, and gNB 103 include a 2D antenna array as described in embodiments of the present disclosure. In some embodiments, one or more of gNB 101, gNB 102, and gNB 103 support codebook designs and structures for systems with 2D antenna arrays.

Although FIG. 1 illustrates an example of the wireless network 100, various changes can be made to FIG. 1. The wireless network 100 can include any number of gNBs and any number of UEs in any suitable arrangement, for example. Furthermore, gNB 101 can directly communicate with any number of UEs and provide wireless broadband access to the network 130 for those UEs. Similarly, each gNB 102-103 can directly communicate with the network 130 and provide direct wireless broadband access to the network 130 for the UEs. In addition, gNB 101, 102 and/or 103 can provide access to other or additional external networks, such as external telephone networks or other types of data networks.

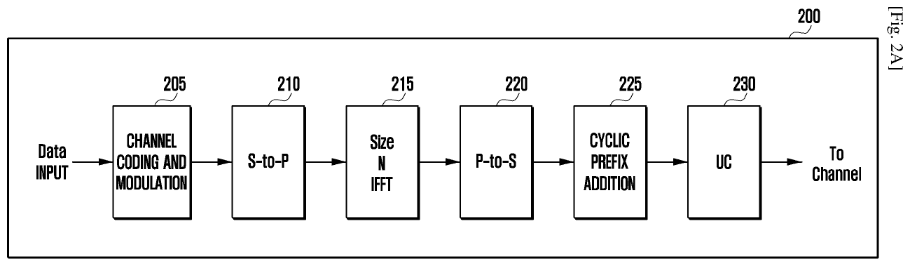

FIGS. 2A and 2B illustrate example wireless transmission and reception paths according to the present disclosure. In the following description, the transmission path 200 can be described as being implemented in a gNB, such as gNB 102, and the reception path 250 can be described as being implemented in a UE, such as UE 116. However, it should be understood that the reception path 250 can be implemented in a gNB and the transmission path 200 can be implemented in a UE. In some embodiments, the reception path 250 is configured to support codebook designs and structures for systems with 2D antenna arrays as described in embodiments of the present disclosure.

The transmission path 200 includes a channel coding and modulation block 205, a Serial-to-Parallel (S-to-P) block 210, a size N Inverse Fast Fourier Transform (IFFT) block 215, a Parallel-to-Serial (P-to-S) block 220, a cyclic prefix addition block 225, and an up-converter (UC) 230. The reception path 250 includes a down-converter (DC) 255, a cyclic prefix removal block 260, a Serial-to-Parallel (S-to-P) block 265, a size N Fast Fourier Transform (FFT) block 270, a Parallel-to-Serial (P-to-S) block 275, and a channel decoding and demodulation block 280.

In the transmission path 200, the channel coding and modulation block 205 receives a set of information bits, applies coding (such as Low Density Parity Check (LDPC) coding), and modulates the input bits (such as using Quadrature Phase Shift Keying (QPSK) or Quadrature Amplitude Modulation (QAM)) to generate a sequence of frequency-domain modulated symbols. The Serial-to-Parallel (S-to-P) block 210 converts (such as demultiplexes) serial modulated symbols into parallel data to generate N parallel symbol streams, where N is a size of the IFFT/FFT used in gNB 102 and UE 116. The size N IFFT block 215 performs IFFT operations on the N parallel symbol streams to generate a time-domain output signal. The Parallel-to-Serial block 220 converts (such as multiplexes) parallel time-domain output symbols from the Size N IFFT block 215 to generate a serial time-domain signal. The cyclic prefix addition block 225 inserts a cyclic prefix into the time-domain signal. The upconverter 230 modulates (such as up-converts) the output of the cyclic prefix addition block 225 to an RF frequency for transmission via a wireless channel. The signal can also be filtered at a baseband before switching to the RF frequency.

The RF signal transmitted from gNB 102 arrives at UE 116 after passing through the wireless channel, and operations in reverse to those at gNB 102 are performed at UE 116. The down-converter 255 down-converts the received signal to a baseband frequency, and the cyclic prefix removal block 260 removes the cyclic prefix to generate a serial time-domain baseband signal. The Serial-to-Parallel block 265 converts the time-domain baseband signal into a parallel time-domain signal. The Size N FFT block 270 performs an FFT algorithm to generate N parallel frequency-domain signals. The Parallel-to-Serial block 275 converts the parallel frequency-domain signal into a sequence of modulated data symbols. The channel decoding and demodulation block 280 demodulates and decodes the modulated symbols to recover the original input data stream.

Each of gNBs 101-103 may implement a transmission path 200 similar to that for transmitting to UEs 111-116 in the downlink, and may implement a reception path 250 similar to that for receiving from UEs 111-116 in the uplink. Similarly, each of UEs 111-116 may implement a transmission path 200 for transmitting to gNBs 101-103 in the uplink, and may implement a reception path 250 for receiving from gNBs 101-103 in the downlink.

Each of the components in FIGS. 2A and 2B can be implemented using only hardware, or using a combination of hardware and software/firmware. As a specific example, at least some of the components in FIGS. 2A and 2B may be implemented in software, while other components may be implemented in configurable hardware or a combination of software and configurable hardware. For example, the FFT block 270 and IFFT block 215 may be implemented as configurable software algorithms, in which the value of the size N may be modified according to the implementation.

Furthermore, although described as using FFT and IFFT, this is only illustrative and should not be interpreted as limiting the scope of the present disclosure. Other types of transforms can be used, such as Discrete Fourier transform (DFT) and Inverse Discrete Fourier Transform (IDFT) functions. It should be understood that for DFT and IDFT functions, the value of variable N may be any integer (such as 1, 2, 3, 4, etc.), while for FFT and IFFT functions, the value of variable N may be any integer which is a power of 2 (such as 1, 2, 4, 8, 16, etc.).

Although FIGS. 2A and 2B illustrate examples of wireless transmission and reception paths, various changes may be made to FIGS. 2A and 2B. For example, various components in FIGS. 2A and 2B can be combined, further subdivided or omitted, and additional components can be added according to specific requirements. Furthermore, FIGS. 2A and 2B are intended to illustrate examples of types of transmission and reception paths that can be used in a wireless network. Any other suitable architecture can be used to support wireless communication in a wireless network.

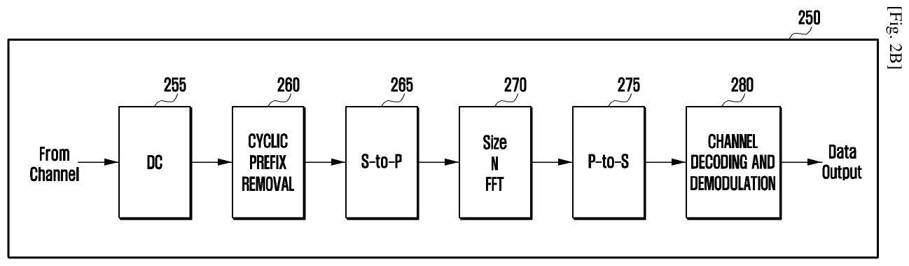

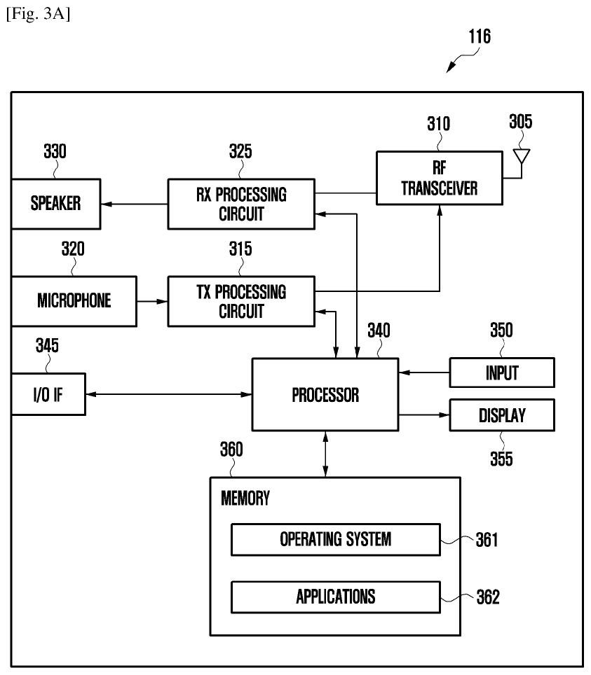

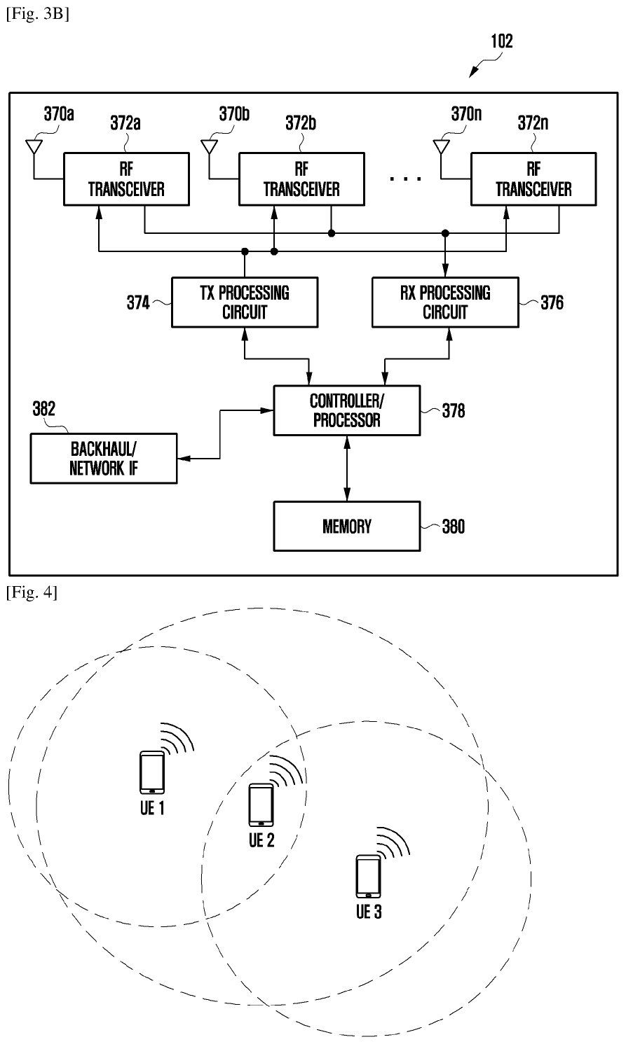

FIG. 3A illustrates an example UE 116 according to the present disclosure. The embodiment of UE 116 shown in FIG. 3A is for illustration only, and UEs 111-115 of FIG. 1 can have the same or similar configuration. However, a UE has various configurations, and FIG. 3A does not limit the scope of the present disclosure to any specific implementation of the UE.

UE 116 includes an antenna 305, a radio frequency (RF) transceiver 310, a transmission (TX) processing circuit 315, a microphone 320, and a reception (RX) processing circuit 325. UE 116 also includes a speaker 330, a processor/controller 340, an input/output (I/O) interface 345, an input device(s) 350, a display 355, and a memory 360. The memory 360 includes an operating system (OS) 361 and one or more applications 362.

The RF transceiver 310 receives an incoming RF signal transmitted by a gNB of the wireless network 100 from the antenna 305. The RF transceiver 310 down-converts the incoming RF signal to generate an intermediate frequency (IF) or baseband signal. The IF or baseband signal is transmitted to the RX processing circuit 325, where the RX processing circuit 325 generates a processed baseband signal by filtering, decoding and/or digitizing the baseband or IF signal. The RX processing circuit 325 transmits the processed baseband signal to speaker 330 (such as for voice data) or to processor/controller 340 for further processing (such as for web browsing data).

The TX processing circuit 315 receives analog or digital voice data from microphone 320 or other outgoing baseband data (such as network data, email or interactive video game data) from processor/controller 340. The TX processing circuit 315 encodes, multiplexes, and/or digitizes the outgoing baseband data to generate a processed baseband or IF signal. The RF transceiver 310 receives the outgoing processed baseband or IF signal from the TX processing circuit 315 and up-converts the baseband or IF signal into an RF signal transmitted via the antenna 305.

The processor/controller 340 can include one or more processors or other processing devices and execute an OS 361 stored in the memory 360 in order to control the overall operation of UE 116. For example, the processor/controller 340 can control the reception of forward channel signals and the transmission of backward channel signals through the RF transceiver 310, the RX processing circuit 325 and the TX processing circuit 315 according to well-known principles. In some embodiments, the processor/controller 340 includes at least one microprocessor or microcontroller.

The processor/controller 340 is also capable of executing other processes and programs residing in the memory 360, such as operations for channel quality measurement and reporting for systems with 2D antenna arrays as described in embodiments of the present disclosure. The processor/controller 340 can move data into or out of the memory 360 as required by an execution process. In some embodiments, the processor/controller 340 is configured to execute the application 362 based on the OS 361 or in response to signals received from the gNB or the operator. The processor/controller 340 is also coupled to an I/O interface 345, where the I/O interface 345 provides UE 116 with the ability to connect to other devices such as laptop computers and handheld computers. I/O interface 345 is a communication path between these accessories and the processor/controller 340.

The processor/controller 340 is also coupled to the input device(s) 350 and the display 355. An operator of UE 116 can input data into UE 116 using the input device(s) 350. The display 355 may be a liquid crystal display or other display capable of presenting text and/or at least limited graphics (such as from a website). The memory 360 is coupled to the processor/controller 340. A part of the memory 360 can include a random access memory (RAM), while another part of the memory 360 can include a flash memory or other read-only memory (ROM).

Although FIG. 3A illustrates an example of UE 116, various changes can be made to FIG. 3A. For example, various components in FIG. 3A can be combined, further subdivided or omitted, and additional components can be added according to specific requirements. As a specific example, the processor/controller 340 can be divided into multiple processors, such as one or more central processing units (CPUs) and one or more graphics processing units (GPUs). Furthermore, although FIG. 3A illustrates that the UE 116 is configured as a mobile phone or a smart phone, UEs can be configured to operate as other types of mobile or fixed devices.

FIG. 3B illustrates an example gNB 102 according to the present disclosure. The embodiment of gNB 102 shown in FIG. 3B is for illustration only, and other gNBs of FIG. 1 can have the same or similar configuration. However, a gNB has various configurations, and FIG. 3B does not limit the scope of the present disclosure to any specific implementation of a gNB. It should be noted that gNB 101 and gNB 103 can include the same or similar structures as gNB 102.

As shown in FIG. 3B, gNB 102 includes multiple antennas 370a-370n, multiple RF transceivers 372a-372n, a transmission (TX) processing circuit 374, and a reception (RX) processing circuit 376. In certain embodiments, one or more of the multiple antennas 370a-370n include a 2D antenna array. gNB 102 also includes a controller/processor 378, a memory 380, and a backhaul or network interface 382.

RF transceivers 372a-372n receive an incoming RF signal from antennas 370a-370n, such as a signal transmitted by UEs or other gNBs. RF transceivers 372a-372n downconvert the incoming RF signal to generate an IF or baseband signal. The IF or baseband signal is transmitted to the RX processing circuit 376, where the RX processing circuit 376 generates a processed baseband signal by filtering, decoding and/or digitizing the baseband or IF signal. RX processing circuit 376 transmits the processed baseband signal to controller/processor 378 for further processing.

The TX processing circuit 374 receives analog or digital data (such as voice data, network data, email or interactive video game data) from the controller/processor 378. TX processing circuit 374 encodes, multiplexes and/or digitizes outgoing baseband data to generate a processed baseband or IF signal. RF transceivers 372a-372n receive the outgoing processed baseband or IF signal from TX processing circuit 374 and upconvert the baseband or IF signal into an RF signal transmitted via antennas 370a-370n.

The controller/processor 378 can include one or more processors or other processing devices that control the overall operation of gNB 102. For example, the controller/processor 378 can control the reception of forward channel signals and the transmission of backward channel signals through the RF transceivers 372a-372n, the RX processing circuit 376 and the TX processing circuit 374 according to well-known principles. The controller/processor 378 can also support additional functions, such as higher-level wireless communication functions. For example, the controller/processor 378 can perform a Blind Interference Sensing (BIS) process such as that performed through a BIS algorithm, and decode a received signal from which an interference signal is subtracted. A controller/processor 378 may support any of a variety of other functions in gNB 102. In some embodiments, the controller/processor 378 includes at least one microprocessor or microcontroller.

The controller/processor 378 is also capable of executing programs and other processes residing in the memory 380, such as a basic OS. The controller/processor 378 can also support channel quality measurement and reporting for systems with 2D antenna arrays as described in embodiments of the present disclosure. In some embodiments, the controller/processor 378 supports communication between entities such as web RTCs. The controller/processor 378 can move data into or out of the memory 380 as required by an execution process.

The controller/processor 378 is also coupled to the backhaul or network interface 382. The backhaul or network interface 382 allows gNB 102 to communicate with other devices or systems through a backhaul connection or through a network. The backhaul or network interface 382 can support communication over any suitable wired or wireless connection(s). For example, when gNB 102 is implemented as a part of a cellular communication system, such as a cellular communication system supporting 5G or new radio access technology or NR, LTE or LTE-A, the backhaul or network interface 382 can allow gNB 102 to communicate with other gNBs through wired or wireless backhaul connections. When gNB 102 is implemented as an access point, the backhaul or network interface 382 can allow gNB 102 to communicate with a larger network, such as the Internet, through a wired or wireless local area network or through a wired or wireless connection. The backhaul or network interface 382 includes any suitable structure that supports communication through a wired or wireless connection, such as an Ethernet or an RF transceiver.

The memory 380 is coupled to the controller/processor 378. A part of the memory 380 can include an RAM, while another part of the memory 380 can include a flash memory or other ROMs. In certain embodiments, multiple instructions, such as the BIS algorithm, are stored in the memory. The multiple instructions are configured to cause the controller/processor 378 to execute the BIS process and decode the received signal after subtracting at least one interference signal determined by the BIS algorithm.

As will be described in more detail below, the transmission and reception paths of gNB 102 (implemented using RF transceivers 372a-372n, TX processing circuit 374 and/or RX processing circuit 376) support aggregated communication with FDD cells and TDD cells.

Although FIG. 3B illustrates an example of gNB 102, various changes may be made to FIG. 3B. For example, gNB 102 can include any number of each component shown in FIG. 3A. As a specific example, the access point can include many backhaul or network interfaces 382, and the controller/processor 378 can support routing functions to route data between different network addresses. As another specific example, although shown as including a single instance of the TX processing circuit 374 and a single instance of the RX processing circuit 376, gNB 102 can include multiple instances of each (such as one for each RF transceiver).

The exemplary embodiments of the present disclosure are further described below in conjunction with the accompanying drawings.

The text and drawings are provided as examples only to help readers understand the present disclosure. They are not intended and should not be interpreted as limiting the scope of the present disclosure in any way. Although certain embodiments and examples have been provided, based on the content disclosed herein, it is obvious to those skilled in the art that modifications to the illustrated embodiments and examples can be made without departing from the scope of the present disclosure.

In the Long Term Evolution (LTE) technology, sidelink communication includes direct communication of device to device (D2D) and vehicle to everything communication (vehicle to vehicle/infrastructure/pedestrian/network, collectively referred to as V2X for simplicity), among which the V2X is designed on the basis of the D2D technology, is superior to D2D in terms of data rate, latency, reliability and link capacity, and is the most representative sidelink communication technology in the LTE technology. In 5G system, the sidelink communication mainly includes the vehicle-to-everything (V2X) communication at present.

There are several sidelink physical channels defined in the NR V2X system, including the PSCCH (Physical Sidelink Control Channel), the PSSCH (Physical Sidelink Shared Channel) and the PSFCH (physical side link feedback channel). The PSSCH is used to carry data, and the PSCCH is used to carry sidelink control information (SCI), in which information, such as time-frequency domain resource locations, the modulation and coding mode, and receiving destination ID corresponding to the PSSCH associated with the PSSCH transmission, is indicated, and the PSFCH is used to carry HARQ-ACK information corresponding to data.

In the NR V2X system, at present, the slot in the 5G system is used as the minimum unit of time domain resource allocation, and the sub-channel is defined as the minimum unit of frequency domain resource allocation. A sub-channel is configured as several RBs in the frequency domain, and a sub-channel may include resources corresponding to at least one of the PSCCH, the PSSCH and the PSFCH.

From the perspective of resource allocation, the 5G sidelink communication system includes two modes: a resource allocation mode based on base station scheduling and a resource allocation mode of UE autonomous selection. In the 5G V2X system, the resource allocation mode based on base station scheduling and the resource allocation mode of UE autonomous selection are called mode 1 and mode 2, respectively.

For mode 1, a method of scheduling resources for the sidelink UE by a base station includes: sending a sidelink grant to the sidelink UE, in which several or periodic sidelink resources for the sidelink UE are indicated. The sidelink grant includes a dynamic grant and a configured grant, in which the dynamic grant is indicated by DCI, the configured grant further includes class 1 and class 2 configured grants, in which the class 1 configured grant is indicated by RRC signaling, and the class 2 configured grant is indicated by RRC signaling and activated/deactivated by DCI.

For mode 2, a method of autonomously selecting resources by a sidelink UE includes: the UE always keeps monitoring and caching a sidelink resource pool, and before the sidelink transmission required to be sent, a channel sensing time window and a resource selection time window is determined according to the expected time range of sending the sidelink transmission, channel sensing is performed in the channel sensing time window, the sidelink resources already reserved by other sidelink UEs is excluded in the resource selection time window according to the channel sensing result, and resources for the sidelink transmission is randomly selected from the sidelink resources that are not excluded in the resource selection time window.

In mode 2, since the transmission resource is determined by the data sending UE based on sensing, the determination process actually depends on the radio environment of the sending UE rather than the receiving UE. Because the radio environments of the sending and receiving UEs are different and the detected interferences are different, the transmission resources determined by the sending UE may not have good link quality with respect to the receiving UE. Therefore, a technology called inter-UE coordination (IUC) is introduced into the sidelink communication system. In this technology, the receiving UE provides the sending UE with information such as the resources preferred by the receiving UE, the resources not preferred by the receiving UE, the detected conflicts or the expected conflicts, etc., which can be used by the sending UE to help it select the sidelink resources for transmitting its own data. This technology can be further expanded, in which the first UE sends IUC information (IUCI) to the second UE for selecting the second UE's transmission resources. In a more expanded scenario, it is not limited whether the first UE and the second UE have a communication relationship, for example, the transmission of the second UE can be sent to the first UE or to another node, such as a third UE.

A slot in the embodiments of the application can be either a subframe or a slot in a physical sense or a subframe or a slot in a logical sense. Specifically, the subframe or slot in the logical sense is a subframe or slot corresponding to a resource pool of sidelink communication. For example, in the V2X system, the resource pool is defined by a repeated bitmap, which maps to a specific set of slots, which can be all slots, or all other slots except some specific slots (such as slots for transmitting MIB/SIB). The slot indicated as “1” in the bitmap can be used for a V2X transmission and belongs to the slot corresponding to the V2X resource pool; the slot indicated as “0” cannot be used for a V2X transmission and does not belong to the slot corresponding to the V2X resource pool.

The difference between subframes or slots in the physical sense and the logical sense will be illustrated in the following through a typical application scenario: when calculating the time-domain gap between two specific channels/messages (such as a PSSCH carrying sidelink data and a PSFCH carrying corresponding feedback information), it is assumed that the gap is N slots. If calculating the subframes or slots in the physical sense, the N slots correspond to an absolute time length of N*x milliseconds in the time domain, and x is a time length of a physical slot (a subframe) in the numerology in this scenario. Otherwise, if calculating subframes or slots in the logical sense, taking the sidelink resource pool defined by the bitmap as an example, the gap of the N slots corresponds to the N slots indicated as “1” in the bitmap, and the absolute time length of the gap varies with the specific configuration of the sidelink communication resource pool and is not a fixed value.

Further, the slot in the embodiment of the present application may be a complete slot or several symbols corresponding to sidelink communication in a slot. For example, when sidelink communication is configured to be performed on the X1th-X2th symbols of each slot, the slot in the following embodiment is the X1th-X2th symbols in the slot in this scenario; alternatively, when the sidelink communication is configured as a mini-slot transmission, the slot in the following embodiments is a mini-slot defined or configured in the sidelink system, rather than a slot in the NR system; alternatively, when the sidelink communication is configured as a symbol level transmission, the slot in the following embodiments may be replaced with a symbol, or may be replaced with N symbols which are the time domain granularity of a symbol level transmission.

In the embodiment of the application, the information, which is configured by the base station, indicated by signaling, configured by the higher layer, or pre-configured, includes a group of configuration information; it further comprises multiple groups of configuration information, from which the UE selects a group of configuration information for use according to a predefined condition; it also includes a group of configuration information including multiple subsets, from which the UE selects one subset for use according to a predefined condition.

Some technical solutions provided in the embodiment of the present application are specifically described based on a V2X system, but the application scenario thereof should not be limited to the V2X system in sidelink communication, but can also be applied to other sidelink transmission systems. For example, the design based on a V2X sub-channel in the following embodiment can also be used for the D2D subchannel or the sub-channel of other sidelink transmissions. In other sidelink transmission system, such as the D2D sidelink transmission system, the V2X resource pool in the following embodiment can also be replaced by a D2D resource pool.

In the embodiment of the present application, when the sidelink communication system is a V2X system, the terminal or the UE may be various types of terminals or UEs, such as a vehicle, an infrastructure, a pedestrian, etc.

In order to make the purpose, technical solution and advantages of this application clearer, the embodiment of this application will be described in further detail below with reference to the drawings.

In the embodiment of the present application, below a threshold can also be replaced by below or equal to the threshold; above (over) a threshold can also be replaced by above or equal to the threshold. Less than or equal to can also be replaced with at least one of less than and equal to; greater than or equal to can also be replaced by at least one of greater than and equal to.

In the traditional communication system, a DRX system is called discontinuous reception because it mainly corresponds to a PDCCH reception. In the sidelink communication system, the DRX mechanism can be used for the transmission and reception of the UE. Accordingly, in the embodiment of the present application, DTX (discontinuous transmission) and DRX (discontinuous reception) can be replaced with each other, and the protection scope should not be affected by different names.

The base station in the present specification can also be replaced by other nodes, such as sidelink nodes, a specific example of which is an infrastructure UE in the sidelink system.

In the present specification, the active/inactive period and the measurement window of measurement configured by the DRX may include a physical slot, and/or a logical slot, wherein the logical slot include a slot allocated to the sidelink resource pool.

In the present specification, re-evaluation and pre-emption occur after the UE selects the resources for a sidelink transmission. The re-evaluation mainly means that when UE has selected the resource for a sidelink transmission and has not performed transmission on the resource, and has not reserved the resource in the previous transmission, the UE decides to give up using the resources because it detects the conflict on the resource. The preemption is similar to the re-evaluation, but it mainly means that after the UE has reserved the resource for a sidelink transmission by way of signaling indication, the UE decides to give up using the resource because it detects the conflict on the resources.

In the resource allocation mode 2 (that is, the mode in which the UE autonomously selects transmission resources), when the UE needs to send data, it can determine which resources have been used by other UEs by monitoring sidelink control information (SCI) of the other UEs in the sidelink resource pool, and select idle resource for the UE's own transmission, in order to reduce the conflict caused by different UEs selecting the same transmission resource in the mode in which the UE autonomously selects transmission resource. This method is also called a resource determination method based on channel sensing.

The main problem of the method is that the resource determination made by the sending UE is based on the radio interference monitored by the sending UE, rather than the radio interference monitored by the receiving UE. The mismatch of the radio interference between the sending UE and the receiving UE may cause the transmission resources selected by the sending UE to be interfered for the receiving UE. A typical scenario is the problem of hidden nodes in wireless communication systems, as shown in FIG. 4.

FIG. 4 is a schematic diagram of a communication scenario according to an embodiment of the present disclosure.

In FIG. 4, UE1 and UE3, as sending UEs of sidelink data, are out of each other's communication range, so the mutual interference caused by them is hidden for the both, and UE1 and UE3 can't evade the resources used by each other when selecting communication resources. At this time, for the receiving UE2 which is in the communication range of both UE1 and UE3 at the same time, when UE2 is the receiving UE corresponding to UE1, its reception will be interfered by UE3, and vice versa. If UE1 and UE3 just choose the same transmission resource, UE2 may fail to decode any data sent by UE1 or UE3 on the resource.

To solve this hidden node problem, the inter-UE coordination (IUC) mechanism is introduced in the sidelink communication system, in which a receiving UE of a given sidelink communication or another UE not participating in the given sidelink communication provides coordination information to a sending UE. The content of the coordination information includes at least one of the resource preferred or not preferred by the UE that sends the coordination information, the detected conflict, the conflict expected to occur, etc., and the information can be used by the sending UE to assist it in selecting sidelink resource for transmitting its own data.

For the resource preferred/not preferred by the first UE, a typical method is that the first UE performs, based on sensing, determining which resources are preferred (for example, resources without radio interference determined based on sensing) and which resources are not preferred (for example, resources with existing/expected conflicts determined based on sensing, resources that cannot be monitored due to half-duplex, etc.). Therefore, for the IUC technology, the resource determination process based on sensing can be used to generate the content carried by the IUCI.

For the conflict detected/expected to occur by the first UE, a typical method is that if the first UE monitors SCI from more than one UE in the sidelink resource pool, and the SCI from more than one UE indicates the same PSCCH/PSSCH resources, then the first UE considers that a conflict occurs between the more than one UE, and sends IUCI to at least one of the more than one UE, and the content carried in the IUCI corresponds to the detected/expected to occur conflict by the first UE.

When the first UE sends the IUCI to the second UE, if the resource allocation mode 2 is used to send the IUCI, the resources used to transmit the IUCI can also be determined according to the resource determination process based on sensing. Therefore, for the IUC technology, the resource determination process based on sensing can be used to determine the resource used to transmit the IUCI.

When the first UE sends the IUCI to the second UE, if the conflict detected/expected to occur by the first UE is indicated in the IUCI, the resources used for transmitting the IUCI can also be determined according to the resources used by SCI indicating the conflict from other UEs, or according to the resource locations where the conflict will occur.

When IUC is not introduced, in general, UE performs, at one time, a resource determination process based on sensing for a data transmission, and the resource determination processes used for different data transmissions are independent of each other. However, after the introduction of IUC, in order to ensure that the information indicated in the IUCI is available for the UE receiving the IUCI, there needs to be a certain restriction between the time point of sending the IUCI and the time span of the resources indicated in the IUCI. Therefore, in order to support the IUC technology in a sidelink communication system, it is necessary to determine how to deal with the relationship between the above two kinds of resource determination processes based on sensing for different purposes, including timing relationship and other details.

In the sidelink communication system, the method of the IUCI indicating the preferred and/or non-preferred resources of the UE is generally referred to as Scheme 1, and the method of the IUCI indicating the detected/expected conflict of the UE is referred to as Scheme 2. In the sidelink communication system, the UE can determine whether scheme 1 and scheme 2 can be used through high-layer configuration parameters (e.g., interUECoordinationScheme1, interUECoordinationScheme2). In the present specification, the same description is used, and the specific meanings of Scheme 1 and Scheme 2 are not repeated every time they are mentioned.

For the Scheme 2, in the sidelink communication system, it considers how to send IUCI when the UE detects that a conflict occurs between the other two UEs, but it fails to cover the scenario with more than two UEs. When the congestion degree of the resource pool is high, it is very likely that multiple UEs will conflict on the same resource. Therefore, it is necessary to introduce solutions to this scenario.

For Scheme 1, in the sidelink communication system, what kind of signaling is used to carry IUCI has not been defined yet. At present, there are two possible ways, namely, media access control (MAC) control element (CE) and SCI. Therefore, it is necessary to further determine under what circumstances the MAC CE and/or the SCI is used to carry IUCI, and the relationship between the IUCI carried by the MAC CE and the SCI if both are used.

In the present specification, the inter-UE coordination can also be the coordination between a UE and a base station, or the coordination between base stations. Therefore, the UE in the above embodiments can also be replaced by a node including a base station and a UE.

In the present application, the term “communication device” can mean any device used in a communication network, including but not limited to a user equipment and a base station.

In the present application, sidelink control information, sidelink control information format, SCI and SCI format can be used interchangeably.

The present application provides a method for determining sidelink resources in a sidelink communication system, in particular to a method on how to generate IUCI and send it to other sidelink UEs when using inter-UE coordination IUC.

### Embodiment 1

Embodiment 1 illustrates a method for determining a conflict and send corresponding IUCI by a UE for Scheme 2.

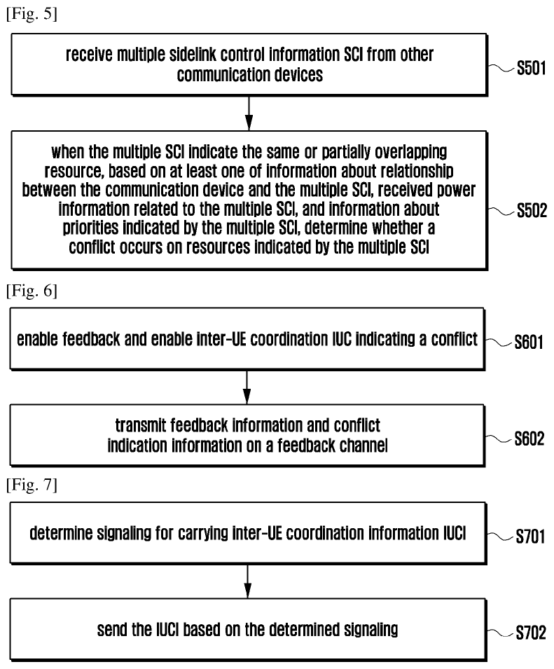

FIG. 5 is a flowchart according to embodiment 1 of the present disclosure.

Referring to FIG. 5, in S501, multiple sidelink control information (SCI) is received from other communication devices. In S502, when the multiple SCI indicate the same or partially overlapping resource, it is determined whether a conflict occurs on the resources indicated by the multiple SCI based on at least one of information about the relationship between the communication devices and the multiple SCI, received power information related to the multiple SC, and information about priorities indicated by the multiple SCI. The information about the relationship between the communication devices and the multiple SCI may include, but is not limited to, at least one of the following: whether the communication device is a destination communication device of the SCI, and whether a destination ID indicated in the SCI is an ID of the communication device.

In an exemplary embodiment, if the UE detects that the same (overlapping) or partially overlapping resource is indicated in more than one SCI format, the UE may determine whether a conflict occurs, and/or if so, whether and how to send corresponding IUCI to indicate the conflict. For example, it is determined that a conflict occurs between more than one SCI format and/or on or between resources indicated by more than one SCI format. Optionally, the UE may determine whether a conflict occurs and whether to send corresponding IUCI to indicate the conflict according to the RSRP and/or information indicated in the SCI format.

Wherein, when multiple SCI formats from the same UE indicate the same or partially overlapping resource, during the process of determining the conflict and sending the corresponding IUCI, they may be treated as one SCI format, or the conflict determination may not be performed on the two SCI formats. For example, UE-1 acquires two SCI formats from the same UE-2, in which one SCI format indicates resource #0, resource #1 and resource #2, and the PSSCH associated with this SCI format is transmitted on resource #0 for the first transmission/retransmission of a certain TB; another SCI format indicates resource #1, resource #2 and resource #3, and the PSSCH associated with this SCI format is transmitted on resource #1 for another retransmission of the above TB. The UE does not need to consider that the above two SCI formats sent by UE-2 will result a conflict on resource #2.

Therefore, the conflict determination method based on the SCI formats in this embodiment may also include the conflict determination method based on the UE: if the UE detects that the same or partially overlapping resource is indicated in SCI formats from more than one UE, the UE may determine whether a conflict occurs, and/or whether and how to send corresponding IUCI to indicate the conflict if the conflict occurs.

When two SCI formats (e.g., first SCI format and second SCI format) indicate the same (overlapping) or partially overlapping resource, or when SCI formats from two UEs (e.g., first SCI format and second SCI format) indicate the same (overlapping) or partially overlapping resource, the following method may be used to determine the conflict.

A UE may consider that a conflict occurs on a first reserved resource r₁ indicated by a first SCI format if at least one of the following conditions is satisfied:
1) if the first reserved resource r₁ overlaps with a second reserved resource r₂ indicated by a second SCI format, and at least one of the following conditions is satisfied:
a) if the UE is a destination UE of a TB to be transmitted in the first reserved resource r₁, and the RSRP measurement performed for the second SCI format RSRP₂ is higher than a certain threshold, for example, the threshold may be determined through Th(prio₂, prio₁), where prio₁ and prio₂ are the priorities indicated in the first and second SCI format, respectively; and/or if the UE is a destination UE of a TB to be transmitted in the second reserved resource r₂, and the RSRP measurement performed for the first SCI format RSRP₁ is higher than a certain threshold, for example the threshold may be determined through Th(prio₁, prio₂) where prio₁ and prio₂ are the priorities indicated in the first and second SCI format, respectively;
b) if the UE is a destination UE of a TB to be transmitted in the first reserved resource r₁, RSRP₂-RSRP₁ is higher than a (pre)configured RSRP threshold; and/or if the UE is a destination UE of a TB to be transmitted in the second reserved resource r₂, RSRP₁-RSRP₂ is higher than a (pre)configured RSRP threshold.
2) if the first reserved resource r₁ occurs in a slot in which the UE does not expect to perform SL reception due to half-duplex operation and the UE is a destination UE of a TB to be transmitted in the first reserved resource r₁.

According to an exemplary embodiment, when more than two SCI formats indicate the same or partially overlapping resource, or when SCI formats from more than two UEs indicate the same (overlapping) or partially overlapping resource, optionally, the UE determines whether a conflict occurs using the following method:

The UE determines, among the more than two SCI formats or the SCI formats from the more than two UEs, whether any two SCI formats or SCI formats from any two UEs indicate the same or (partially) overlapping resource. If so, the above method when the two SCI formats or the SCI formats from the two UEs indicate the same (overlapping) or partially overlapping resource is used to determine whether a conflict occurs between the two SCI formats or the SCI formats from the two UEs, or occurs between the resources indicated by the two SCI formats or occurs on the resource indicated by the SCI formats. It should be noted that here, more than two SCI formats or SCI formats from more than two UE are only taken as examples, and the method of the present disclosure can be applied to SCI formats conforming to other predetermined number ranges or SCI formats from UEs conforming to other predetermined number ranges.

Further, the UE may select multiple SCI pairs according to the priority order, for example, the order of priorities indicated in SCI formats from the high to the low, and use the above method to determine whether any two SCI formats or SCI formats from two UEs conflict with each other pair by pair. As an example, the smaller the value of priority is indicated in an SCI format, the higher the priority is.

According to another exemplary embodiment, when more than two SCI formats indicate the same (overlapping) or partially overlapping resource, or when SCI formats from more than two UEs indicate the same (overlapping) or partially overlapping resource, optionally, when the following conditions are met, the UE determines that a conflict occurs, otherwise, it determines that no conflict occurs:

If the first reserved resource r₁ indicated in the first SCI format overlaps or partially overlaps with at least one second reserved resource r₂ indicated in at least one second SCI format, and the UE can support and is configured with at least one of the following methods:
1) if the UE is a destination UE of a TB to be transmitted on the first reserved resource r₁, and the RSRP of at least one second SCI format (noted as RSRP₂) is higher than a certain threshold, for example, a threshold determined through Th(prio₂, prio₁), where prio₁ is the priority indicated in the first SCI format, prio₂ can be any one of the following: the highest priority, the lowest priority, the average or median of priorities indicated in the at least one second SCI format; or
2) If the UE is a destination UE of a TB to be transmitted on r₁, and the difference between the RSRP of at least one second SCI format (noted as RSRP₂) and the RSRP of the first SCI format (RSRP₁), RSRP₂-RSRP₁, exceeds a threshold.

And/or, optionally, when the following conditions are met, the UE determines that a conflict occurs, otherwise, it determines that no conflict occurs:

If the first reserved resource r₁ indicated in the first SCI format overlap or partially overlap with at least one second reserved resource r₂ indicated in at least one second SCI format, and the UE can support and is configured with at least one of the following methods:
1) If the UE is a destination UE of a TB to be transmitted on the first reserved resource r₁, and the RSRP of at least one second SCI format (noted as RSRP₂) is higher than a certain threshold, for example, a threshold determined through Th(prio₂, prio₁), where prio₁ is the priority indicated in the first SCI format, prio₂ can be any one of the following: the highest priority, the lowest priority, the average or median of priorities indicated in the at least one second SCI format. Optionally, the first SCI format is the SCI format with the highest indicated priority (that is, the value of the indicated priority field is the lowest) among the SCI formats that indicate the first reserved resource r₁ and in which the UE is the destination UE. Optionally, the second SCI format includes any other SCI format except the first SCI format, or the second SCI format includes any SCI format in which the indicated destination UE is not the UE; or
2) If the UE is a destination UE of a TB to be transmitted on r₁, and the difference between the RSRP of at least one second SCI format RSRP (noted as RSRP₂) and the RSRP of the first SCI format (noted as RSRP₁), RSRP₂-RSRP₁, exceeds a threshold. Optionally, the first SCI format is the SCI format with the highest indicated priority (that is, the value of the indicated priority field is the lowest) among the SCI formats that indicate the first reserved resource r₁ and in which the UE is the destination UE, or any one of the SCI formats that indicate the first reserved resource r₁ and in which the UE is the destination UE. Optionally, the second SCI format includes any other SCI format except the first SCI format, or the second SCI format includes any SCI format in which the indicated destination UE is not the UE; or
3) If the UE is a destination UE of a TB to be transmitted on r₂, and the difference between the RSRP of at least one first SCI format (noted as RSRP₁) and the RSRP of the second SCI format (noted as RSRP₂), RSRP₁-RSRP₂, exceeds a threshold. Optionally, the first SCI format is the SCI format with the highest indicated priority (that is, the value of the indicated priority field is the lowest) among the SCI formats that indicate the first reserved resource r₁ and in which the UE is the destination UE, or any one of the SCI formats that indicate the first reserved resource r₁ and in which the UE is the destination UE. Optionally, the second SCI format includes any other SCI format except the first SCI format, or the second SCI format includes any SCI format in which the indicated destination UE is not the UE.

Further, the UE may determine whether a conflict occurs between the more than two SCI formats or SCI formats from more than two UEs in order of priority, for example, the order of priority from high to low. In a specific example, the UE detects N>1 SCI formats, and needs to determine whether a conflict occurs on the resource indicated in each SCI format therein. The UE takes any one of the N SCI formats as a first SCI format and any one of the remaining N−1 SCI formats as a second SCI format, and determines whether a conflict occurs on each first reserved resource r₁ indicated in the first SCI format. Optionally, the other two SCI formats are selected as the first/second SCI format and the process is repeated until any combination of the first SCI format and the second SCI format that can be formed by the N SCI formats is traversed. In another specific example, the UE detects N>1 SCI formats, and needs to determine whether a conflict occurs on the resource indicated in each SCI format therein. In this example, N=N1+N2, and the N SCI formats include N1 SCI formats in which the UE is the destination UE and N2 SCI formats in which other UEs are the destination UEs. The UE takes any one of the N1 SCI formats as the first SCI format, any one of the remaining N2 SCI formats as the second SCI format or any one of the remaining N1−1+N2 SCI formats as the second SCI format, and determines whether a conflict occurs on each first reserved resource r₁ indicated in the first SCI format. Optionally, the other two SCI formats are selected as the first/second SCI format and the process is repeated until any combination of the first SCI format and the second SCI format that can be formed by the N SCI formats is traversed.

If the UE determines that the resource r₁ indicated in the first SCI format conflicts with at least one resource r₂ indicated in at least one second SCI format, the UE, among the SCI formats in which conflicts occur, sends a corresponding conflict indication to other SCI formats except the one SCI format with the highest priority, or sends a corresponding conflict indication to the sending UEs of other SCI formats except the SCI format with the highest priority.

Optionally, when selecting the first and second SCI format pair in the above process, selecting may be performed in order of priority from high to low (that is, the order of the value of priority field from small to large). If there are multiple SCI formats in the same priority, random selection or selection based on other parameters (for example, by at least one method of selecting SCI formats in order of RSRP from high to low, and preferentially selecting the SCI format in which the destination UE is the UE itself) is performed therein.

For example, suppose that the UE receives three SCI{SCI-A, SCI-B, SCI-C} with the priority of 0, one SCI{SCI-D} with the priority of 1 and two SCI{SCI-E, SCI-F} with the priority of 2, then the UE first selects three SCI pairs of SCI-A+SCI-B, SCI-A+SCI-C, SCI-B+SCI-C to determine whether a conflict occurs, then selects SCI-A+SCI-D, SCI-B+SCI-D, SCI-C+SCI-D to determine whether a conflict occurs, by parity of reasoning, until the conflict determination of all SCI pairs is completed.

For another example, the UE detects N=N1+N2 SCI formats, where the N SCI formats include N1 SCI formats in which the UE is the destination UE and N2 SCI formats in which other UEs are the destination UEs. The UE takes the SCI format with the highest priority among the N1 SCI formats as the first SCI format, takes the SCI format with the highest priority among the remaining N2 SCI formats as the second SCI format or takes the SCI format with the highest priority among the remaining N1−1+N2 SCI formats as the second SCI format, determines whether a conflict occurs on each first reserved resource r₁ indicated in the first SCI format; then, takes the SCI format with the highest priority among the N1 SCI formats as the first SCI format, takes the SCI format with the second highest priority among the remaining N2 SCI formats as the second SCI format, or the SCI format with the second highest priority among the remaining N1−1+N2 SCI formats as the second SCI format, determines whether a conflict occurs on each first reserved resource r₁ indicated in the first SCI format; by parity of reasoning, until all the conflict determination between all second SCI formats and the first SCI format is completed. Optionally, the UE again takes the SCI format with the second highest priority among the N1 SCI formats as the first SCI format, takes the SCI format with the highest priority among the remaining N2 SCI formats (which may not include the previous first SCI format, that is, the SCI format with the highest priority among the N1 SCI formats) as the second SCI format or takes the SCI format with the highest priority among the remaining N1−1+N2 SCI formats (which may not include the previous first SCI format, that is, the SCI format with highest priority among the N1 SCI formats) as the second SCI format, determines whether a conflict occurs on each first reserved resource r₁ indicated in the first SCI format; then, takes the SCI format with the second highest priority among the N1 SCI formats as the first SCI format, takes the SCI format with the second highest priority among the remaining N2 SCI formats (which may not include the previous first SCI format, i.e. the SCI format with highest priority among the N1 SCI formats) as the second SCI format or takes the SCI format with the second highest priority among the remaining N1−1+N2 SCI formats (which may not include the previous first SCI format, i.e. the SCI format with highest priority among the N1 SCI formats) as the second SCI format, determines whether a conflict occurs on each first reserved resource r₁ indicated in the first SCI format; by parity of reasoning. Optionally, the first/second SCI format among the N SCI formats is selected in order of priority from high to low, and the process is repeated until traversing any combination of the first SCI format and the second SCI format that the N SCI formats can form. Optionally, in order of priority from high to low, the first SCI format and second format as combination are traversed to complete the conflict determining process, in which the first SCI format are traversed among the N1 SCI formats, and the second SCI format are traversed among the N2 SCI formats or N SCI formats.

If the UE determines whether a conflict occurs by traversing all SCI pairs, the sequence of SCI pairs has no significant impact on the system performance. The main purpose of the method is to be combined with other optimizations. For example, in other subsequent examples of the specification, after detecting a conflict occurs and determining to send a conflict indication to the resource indicated in the corresponding SCI format/corresponding SCI format/corresponding UE, and when determining whether a conflict exists, the UE can remove or exclude the resource indicated in the corresponding SCI format/the corresponding SCI format/the corresponding UE to which the conflict indication is sent from the resources indicated in the received SCI formats/received SCI formats/detected sending UEs, or the resource indicated in the corresponding SCI format/the corresponding SCI format/the corresponding UE to which the conflict indication is sent is not considered or is disabled in the subsequent conflict determining process. For example, if the UE has determined that a conflict occurs on a third reserved resource r₃ indicated in a certain third SCI format, and a conflict indication will be sent to the third SCI format or the sending UE of the third SCI format, the UE does not need to determine whether any resource indicated in the third SCI format conflicts with the resources indicated by other SCI formats, or whether r₃ conflicts with the resources indicated by other SCI formats when the UE continues determining whether a conflict occurs between resources indicated by SCI formats subsequently. Preferably, the former is applicable to a case where the conflict indication is used to trigger the UE receiving the indication to re-select all the resources indicated in the SCI format (except the resources used by the PSSCH corresponding to sending the SCI format), and the latter is applicable to a case where the conflict indication is used to trigger the UE receiving the indication to re-select at least one resource on which a conflict occurs indicated in the conflict indication, and the resources on which no conflict occurs (if any) may not be re-selected. The detailed method is shown in other subsequent specific examples. Combined with this optimization, the advantage of selecting SCI pairs in terms of priority is that only one SCI format with the highest priority will be reserved among the SCI formats in which a conflict occurs, and the rest SCI formats will be removed from the conflict determining process of resources. If UE first determines whether there are conflicts between some SCI format pairs with low priority, the SCI format determined to be reserved is still likely to conflict with other SCI formats with high priority and be removed, thus increasing the system complexity. In addition, if the reserved SCI format conflicts with other SCI formats with high priority and is removed, it is possible that other SCI formats with low priority that conflict with the SCI format no longer have conflicts and do not need to be sent corresponding conflict indications, which will affect the accuracy of the conflict determining process. On the contrary, if the SCI pair is selected according to the priority, the UE can first determine whether a conflict occurs between the SCI format with low priority and the SCI format with the highest priority, if so, the UE will send a conflict indication to the SCI format with the low priority and no longer consider the impact of the SCI format with the low priority on the conflict determining process; after the determination step is completed, the SCI format with the highest priority on which no conflict occurs can be considered to remain in the conflict determining process all the time, thus reducing the complexity of the system and making the result more accurate.

In another specific example, the UE detects N>1 SCI formats, and needs to determine whether a conflict occurs on the resources indicated in each SCI format therein. The UE takes any one of the N SCI formats as the first SCI format and take the remaining N−1 SCI formats as the second SCI formats, and determines whether a conflict occurs on each first reserved resource r₁ indicated in the first SCI format. Optionally, another SCI format is selected as the first SCI format and the process is repeated until the N SCI formats as the first SCI format are traversed.

The UE takes any one of the N SCI formats as the first SCI format and take the remaining N−1 SCI formats as the second SCI formats, determines whether a conflict occurs on each first reserved resource r₁ indicated in the first SCI format. Specifically, it includes: when the UE is configured with a high-layer parameter interUECoordinationScheme2 to enable the transmission of the resource conflict indication, if at least one of the following conditions is met, it is considered that a resource conflict occurs on the first reserved resource r₁ indicated in the received first SCI format:

The first reserved resource r₁ overlaps with at least one second reserved resource r₂ indicated in at least one second SCI format, and:
if the high-layer configuration enables the first method,
   the UE is a destination UE of a TB to be transmitted on r₁, the RSRP measurement performed on the second SCI format RSRP₂ is higher than a threshold Th(prio₂, prio₁), where prio₁ and prio₂ is the priorities indicated in the received first and second SCI formats, respectively;
   or if the UE is a destination UE of a TB to be transmitted on r₂, the RSRP measurement performed on the first SCI format RSRPᵢ is higher than the threshold Th(prio₁, prio₂), where prio₁ and prio₂ is the priorities indicated in the received first and second SCI formats, respectively;
or if the high-layer configuration enables the second method and the UE supports the second method,
   if the UE is a destination UE of a TB to be transmitted on r₁, RSRP₂-RSRP₁ is higher than a (pre)configured RSRP threshold;
   or if the UE is a destination UE of a TB to be transmitted on r₂, RSRP₁-RSRP₂ is higher than a (pre)configured RSRP threshold.

Optionally, when there are multiple second SCI formats indicating at least one r₂ overlapping with r₁, at least one of the following methods is used:
based on the priority indicated in each second SCI format, respectively determining: whether the RSRP measurement performed on the second SCI format RSRP₂ is higher than the threshold Th(prio₂, prio₁), or whether the RSRP measurement performed on the first SCI format RSRP₁ is higher than the threshold Th(prio₁, prio₂), or whether RSRP₂-RSRP₁ or RSRP₁-RSRP₂ is higher than a (pre)configured RSRP threshold; where prio₂ is the priority indicated in each SCI format in the second SCI formats and prio₁ is the priority indicated in the first SCI format;
determining, based on the highest priority indicated in the multiple second SCI formats, whether RSRP measurements performed on the multiple second SCI formats RSRP₂ is higher than the threshold Th(prio₂, prio₁), or whether RSRP measurement performed on the first SCI format RSRP₁ is higher than the threshold Th(prio₁, prio₂), or whether RSRP₂-RSRP₁ or RSRP₁-RSRP₂ is higher than a (pre)configured RSRP threshold; where prio₂ is the highest priority indicated in multiple SCI formats among the second SCI formats and prio₁ is the priority indicated in the first SCI format;
Wherein, the higher priority corresponds to the lower value of the priority field.

Optionally, when selecting a certain SCI format as the first SCI format in the above process, it is selected according to the order of priority from high to low (that is, the order of the value of priority field from small to large). If there are multiple SCI formats in the same priority, they are randomly selected or selected based on other parameters (for example, by at least one method of selecting the SCI format in order of the RSRP from high to low, and preferentially selecting the SCI format in which the destination UE is the UE itself). For example, determination is made by taking a SCI format with the highest priority as the first SCI format, and the remaining N−1 SCI formats as the second SCI formats; then a determination is made by taking a SCI format with the highest priority among the remaining N−1 SCI formats (if some SCI formats are removed in the previous determination, the number can be less than N−1 here) as the first SCI format and the remaining N−2 SCI formats (if some SCI formats are removed in the previous determination, the number can be less than N−2 here) as the second SCI formats, by parity of reasoning.

The advantage of this method is similar to that in the previous specific example. After combining the mechanism of removing the resource/SCI format/UE to which a conflict indication is determined to be sent from the conflict determining process, the system complexity can be reduced and the accuracy of the conflict determination result can be ensured.

As for the UE detecting that more than one SCI format indicates the same or (partially) overlapping resource, optionally, at least one of the following can be included:
in more than one SCI format detected by the UE, for the resources indicated in any two SCI formats, determining whether there is the same or (partially) overlapping resource therein;
in more than one SCI format detected by the UE, for the resource indicated in any one SCI format, determining whether all remaining SCI formats indicate the same or (partially) overlapping resource as or with the any one SCI format; wherein the any one SCI format can be any one of the SCI formats that meet a specific condition, which includes that the destination ID indicated in the SCI format is the ID of the UE;
for any one resource in a given resource set, determining whether there are more than one SCI format indicating a resource including the any one resource among the SCI formats detected by the UE, wherein the granularity of the any one resource in time domain and frequency domain can be configured/preset, for example, a slot in time domain and a subchannel in frequency domain.

For the first two methods, further, the UE selects any two SCI formats mentioned above for determination or any one SCI format for determination according to the configured/predetermined order, which can be based on at least one of the following: the priority indicated by the SCI format, the RSRP of the SCI format, the size of the overlapping resources in time domain and/or frequency domain, and the percentage of overlapping resources to the total transmission resources in time domain and/or frequency domain.

For the latter method, further, the given resource set includes at least one of a resource pool, a specific time domain and/or frequency domain range, and a specific resource set, and the time domain and/or frequency domain range or the specific resource set may be determined based on the resource pool and/or the sidelink reception of the UE itself, where the resource pool is a resource pool used by the UE to receive the SCI, and is configured or indicated through, for example, information received through the sidelink of the UE itself and/or information related to the sidelink reception of the UE itself. For example, if the UE detects at least one SCI-3 and is the destination UE of the SCI-3, the UE performs the latter method mentioned above for a resource set {r₁, r₂, r₃, . . . rₙ}, which is a set that includes all the resources indicated in the at least one SCI-3.

In a specific example, the UE receives three SCI formats, SCI-1, SCI-2 and SCI-3, indicating resources {r₁₋ₐ, r_{1-b}, r_{1-c}}, {r₂₋ₐ, r_{2-b}}, {r₃₋ₐ, r_{3-b}} respectively, and indicating priorities 0, 1 and 2 respectively. The UE detecting whether the same (overlapping) or partially overlapping resource is indicated in the above three SCI formats includes:
the UE determining whether the resources indicated in SCI-1 and SCI-2 are the same (overlapping) or partially overlapping, specifically, determining that there is any more than one same (overlapping) or partially overlapping resource among the resources r₁₋ₐ, r_{1-b}, r_{1-c}, r₂₋ₐ, r_{2-b}. For example, supposing that the resource r₁₋ₐ is subchannel 0-5 in slot t0, and the resource r₂₋ₐ is subchannel 3-6 in slot t0, UE determines that resource r₁₋ₐ and resource r₂₋ₐ partially overlap, so a conflict occurs between the resource r₁₋ₐ and the resource r₂₋ₐ;
the UE determining whether the resources indicated in SCI-1 and SCI-3 are the same (overlapping) or partially overlapping, specifically, determining that there is any more than one same (overlapping) or partially overlapping resource among the resources r₁₋ₐ, r_{1-b}, r_{1-c}, r₃₋ₐ and r_{3-b};
the UE determining whether the resources indicated in SCI-2 and SCI-3 are the same (overlapping) or partially overlapping, specifically, determining there is any more than one resource the same (overlapping) or partially overlapping among the resources r₂₋ₐ, r_{2-b}, r₃₋ₐ and r_{3-b}.

In another specific example, the UE receives three SCI formats, SCI-1, SCI-2 and SCI-3, indicating resources {r₁₋ₐ, r_{1-b}, r_{1-c}}, {r₂₋ₐ, r_{2-b}} and {r₃₋ₐ, r_{3-b}} respectively, and indicating priorities 0, 1 and 2 respectively. The UE detecting whether the same (overlapping) or partially overlapping resource is indicated in the above three SCI formats includes:
the UE determining whether the resources indicated in SCI-2 and SCI-3 are the same as (overlap with) or partially overlap with any resource among the resources {r₁₋ₐ, r_{1-b}, r_{1-c}} indicated by SCI-1;
the UE determining whether the resources indicated in SCI-1 and SCI-3 are the same as (overlap with) or partially overlap with any resource among the resources {r₂₋ₐ, r_{2-b}} indicated in SCI-2; further, since SCI-1 has been compared with SCI-2, the UE can only determine whether the resources indicated in SCI-3 are the same as (overlap with) or partially overlap with any resources among the resources {r₂₋ₐ, r_{2-b}} indicated in SCI-2;
the UE determining whether the resources indicated in SCI-1 and SCI-2 are the same as (overlap with) or partially overlap with any resource among the resources {r₃₋ₐ, r_{3-b}} indicated in SCI-3; furthermore, since both SCI-1 and SCI-2 have been compared with SCI-3, the UE can skip this step.

In another specific example, the UE receives three SCI formats, SCI-1, SCI-2 and SCI-3, indicating resources {r₁₋ₐ, r_{1-b}, r_{1-c}}, {r₂₋ₐ, r_{2-b}} and {r₃₋ₐ, r_{3-b}} respectively, and indicating priorities 0, 1 and 2 respectively. Wherein, the destination UE of SCI-3 is the UE, and the destination UE of the other SCI is not the UE. The UE detecting whether the same (overlapping) or partially overlapping resource is indicated in the above three SCI formats, includes the following methods:
for any one resource in a given resource set, determining whether more than one resource or resources from more than one UE in the resources {r₁₋ₐ, r_{1-b}, r_{1-c}}, {r₂₋ₐ, r_{2-b}}, {r₃₋ₐ, r_{3-b}} includes the any one resource. The granularity of the any one resource in time domain and frequency domain can be configured/preset. The given resource set can be a resource pool, or slots t0-t1 and sub-channels f0-f1 of a given time frequency range in the resource pool, and the given time frequency range can be based on configuration/preset.

For example, the granularity of the resource is a slot in time domain and a sub-channel in frequency domain, which is denoted as a sub-channel f on a slot t, where t traverses t0˜t1 and f traverses f0˜f1. The UE determines whether more than one resource or resources from more than one UE among the resources {r₁₋ₐ, r_{1-b}, r_{1-c}}, {r₂₋ₐ, r_{2-b}} and {r₃₋ₐ, r_{3-b}} includes sub-channel f on slot t. Assuming that the resource r₁₋ₐ is sub-channels 0-5 on slot t0 and the resource r₂₋ₐ is sub-channels 3-6 on slot t0, the UE determines that the resources r₁₋ₐ and r₂₋ₐ are in conflict on the following three resources: sub-channel 3 in slot t0, sub-channel 4 in slot t0 and sub-channel 5 in slot t0.

In addition, the following methods can also be included:
for any one resource in a given resource set, determining whether more than one resource or resources from more than one UE in the resources {r₁₋ₐ, r_{1-b}, r_{1-c}}, {r₂₋ₐ, r_{2-b}}, {r₃₋ₐ, r_{3-b}} includes the any one resource. The granularity of the any one resource in time domain and frequency domain can be configured/preset. The given resource set is determined based on the sidelink reception of the UE itself, for example, based on all the resources indicated in the received SCI format in which the destination ID is the ID of the UE itself.

For example, supposing that the resource r₃₋ₐ is subchannel 2-4 on slot t1, and the resource r_{3-b} is subchannel 3-5 on slot t2, the given resource set includes {subchannel 2 on slot t1, subchannel 3 on slot t1, subchannel 4 on slot t1, subchannel 3 on slot t2, subchannel 4 on slot t2 and subchannel 5 on slot t2}. For each resource in the given resource set, the UE determines whether more than one resource or a resource from more than one UE in the resources {r₁₋ₐ, r_{1-b}, r_{1-c}}, {r₂₋ₐ, r_{2-b}}, {r₃₋ₐ, r_{3-b}} includes the resource. Assuming that the resource r₁₋ₐ is sub-channels 0-5 on slot t1 and the resource r₂₋ₐ is sub-channels 3-6 on slot t1, the UE determines that r₁₋ₐ and r₂₋ₐ are in conflict on the following two resources: sub-channel 3 in slot t0 and sub-channel 4 in slot t0. On the sub-channel 5 on the slot t1, although a conflict occurs on the resource r₁₋ₐ and the resource r₂₋ₐ, the UE does not need to determine whether a conflict occurs on the sub-channel 5 on the slot t1 because it is not in the given resource set.

Preferably, this method is used in the scenario where the UE only sends the conflict indication to its sending UE (that is, the UE that sends the SCI format when the destination ID indicated in the SCI format is the ID of the UE).

Optionally, for the UE determining whether a conflict occurs in more than one detected SCI format, and/or whether and how to send corresponding IUCI to indicate the conflict if a conflict occurs, it further includes:
the UE sorts the more than one detected SCI format in a predetermined order, and sequentially detects whether a conflict occurs in the more than one detected SCI format, if so, sends a conflict indication to other SCI formats except the SCI format with the highest priority, and/or sends a conflict indication to the UEs from which other SCI formats come except the UE from which the SCI format with the highest priority comes; and/or, removes the SCI format or the UE to which the conflict indication is sent from the detected SCI formats or the UEs from which the detected SCI formats come, that is, the SCI format or the UE to which the conflict indication has been determined to send will not be used in the subsequent process of determining whether a conflict occurs. And/or, the resource in which the conflict indication is sent is removed from the resources indicated in the detected SCI formats, that is, the resource that has been determined to send the conflict indication is no longer used in the subsequent process of determining whether a conflict occurs.

The predetermined order is based on at least one of the following: whether the destination UE indicated in the SCI format is the UE; a priority indicated in the SCI format; RSRP of the SCI format. For example, if the predetermined order is the indicated destination UE being the UE>the indicated destination UE being not the UE, and the high priority>the low priority, then the sorting method is as follows: among the SCI formats in which the indicated destination UE is the UE, sorting is performed from high priority to low priority; then, among the SCI formats in which the indicated destination UE is not the UE, sorting is performed from high priority to low priority.

In a specific example, the UE first selects the SCI format with the indicated highest priority (denoted as SCI-1) as the first SCI format, and takes the remaining SCI formats as the above at least one second SCI format to make determination with the first SCI format; then, except the above-mentioned SCI-1, the SCI format which does not conflict with SCI-1 and has the indicated highest priority (denoted as SCI-2) among the remaining SCI formats is selected as the first SCI, and the SCI formats that do not conflict with SCI-1 and are not SCI-2 among the remaining SCI formats are taken as the above-mentioned at least one second SCI format to make determination with the first SCI format; by parity of reasoning.

For example, the UE receives four SCI formats, SCI-1, SCI-2, SCI-3 and SCI-4, indicating resources {r₁₋ₐ, r_{1-b}, r_{1-c}}, {r₂₋ₐ, r_{2-b}}, {r₃₋ₐ, r_{3-b}} and {r₄₋ₐ} respectively, and indicating priorities 0, 1, 2, 3 respectively. The UE detects whether SCI-1 conflicts with at least one of SCI-2, SCI-3 and SCI-4, that is, whether the resource indicated by SCI-1 is the same as or partially overlaps with the resources indicated by at least one of SCI-2, SCI-3 and SCI-4. If the UE determines that the resource r₁₋ₐ and the resource r₃₋ₐ partially overlap, then the UE determines that it needs to send the corresponding conflict indication to SCI-3, and remove SCI-3 from the subsequent conflict determining process. Then, the UE determines whether SCI-2 conflicts with SCI-4, and if there is no conflict, the conflict determining process ends. The final result determined by the UE in this process is that a conflict occurs on the resource r₁₋ₐ and the resource r₃₋ₐ, and the UE needs to send a conflict indication that a conflict occurs on the resource r₃₋ₐ to SCI-3 (or to the sending UE of SCI-3).

In another specific example, the UE sequentially determines whether the SCI format conflicts with other SCI formats in a method similar to that in the previous example, but after the conflict is found, it does not remove the SCI format, but removes the conflicted resources in the SCI format.

For example, the UE receives four SCI formats, SCI-1, SCI-2, SCI-3 and SCI-4, indicating resources {r₁₋ₐ, r_{1-b}, r_{1-c}}, {r₂₋ₐ, r_{2-b}}, {r₃₋ₐ, r_{3-b}} and {r₄₋ₐ} respectively, and indicating priorities 0, 1, 2, 3 respectively. The UE detects whether SCI-1 conflicts with at least one of SCI-2, SCI-3 and SCI-4, that is, whether the resource indicated by SCI-1 is the same as or partially overlaps with the resource indicated by at least one of SCI-2, SCI-3 and SCI-4. If the UE determines that the resource r₁₋ₐ and the resource r₃₋ₐ partially overlap, the UE determines that it needs to send the corresponding conflict indication to SCI-3, and remove the resource r₃₋ₐ from the subsequent conflict determining process. Then, the UE determines whether SCI-2 conflicts with SCI-3 (excluding the resource r₃₋ₐ) and SCI-4, that is, whether the resource indicated by SCI-2 is the same as or partially overlaps with at least one of the resources indicated by SCI-3 (excluding the resource r₃₋ₐ) and SCI-4. The UE determines that there is no conflict. Subsequently, the UE determines whether SCI-3 (excluding the resource r₃₋ₐ) conflicts with SCI-4, that is, whether the resource r_{3-b} and the resource r₄₋ₐ are the same or partially overlap. If the UE determines that the resources r_{3-b} and r₄₋ₐ partially overlap and a conflict occurs, the UE determines that it needs to send the corresponding conflict indication to SCI-4, and remove the resource r₄₋ₐ from the subsequent conflict determining process. The conflict determining process ends. The final result determined by the UE in this process is that a conflict occurs on the resources r₁₋ₐ and r₃₋ₐ, and the UE needs to send a conflict indication that a conflict occurs on the resources r₃₋ₐ to SCI-3 (or to the sending UE of SCI-3); a conflict occurs on the resources r_{3-b} and r₄₋ₐ, and the UE needs to send a conflict indication that a conflict occurs on the resource r₄₋ₐ to SCI-4 (or to the sending UE of SCI-4).

According to another aspect of the embodiment, there is provided a method in which: when the UE enables the HARQ feedback mechanism, for Scheme 2, the UE determines a conflict based on the HARQ state.

In an exemplary embodiment, if the UE is configured to enable HARQ feedback and IUC, the content of IUC is determined based on the state of HARQ feedback. Furthermore, even when the HARQ feedback is not enabled, the UE uses a method similar to HARQ feedback to determine the content of IUC based on whether the data is successfully received.

Specifically, the following at least one method is included:
If the UE detects that a conflict occurs on the first resource r₁ indicated in the first SCI format, and the UE is the destination UE of a TB transmitted on r₁ or the destination UE of the first SCI format, and the UE successfully receives the TB transmitted on r₁ or the TB associated with the first SCI format, or the HARQ feedback of the UE for the TB transmitted on r₁ or the TB associated with the first SCI format is ACK (regardless of whether the ACK will actually be transmitted), then the UE does not need to send a corresponding conflict indication to r₁, including that the UE does not need to send IUCI indicating a conflict corresponding to r₁; further, if at least one other resource r₁′ is also indicated in the first SCI format, the UE does not need to send a corresponding conflict indication to r₁′ regardless of whether a conflict occurs on r₁′, including that the UE does not need to send IUCI indicating a conflict to r₁′;
If, on the first resource r₁ indicated in the first SCI format, the UE detects a conflict with at least one second resource r₂ indicated in at least one second SCI format, and the UE is the destination UE of a TB transmitted on r₂ or the destination UE of the second SCI format, or the HARQ feedback of the UE for the TB transmitted on r₂ or the TB associated with the second SCI format is ACK, then the UE does not need to send a corresponding conflict indication to r₂, including that the UE does not need to send IUCI indicating the conflict corresponding to r₂; further, if the UE also detects that the first resource r₁ indicated in the first SCI format conflicts with at least one third resource r₃ indicated in at least one third SCI format, and the UE is not the destination UE of a TB transmitted on r₃ or the destination UE of the third SCI format, or the UE is the destination UE of a TB transmitted on r₃ or the destination UE of the third SCI format and the HARQ feedback of the UE for the TB transmitted on r₃ or the TB associated with the third SCI format is NACK, the UE still needs to send the corresponding conflict indication to r₃.

Optionally, the above method can not only be used to determine whether to send the IUCI indicating the conflict, but also be used in the conflict determining process. In an exemplary embodiment, if the UE detects that the same (overlapping) or partially overlapping resource is indicated in more than one SCI format, and the HARQ state for the TB corresponding to the more than one SCI format is NACK, and/or the TB associated with the more than one SCI format is not successfully received, the UE determines whether a conflict occurs based on the method in Embodiment 1.

Further, if the UE detects that the same (overlapping) or partially overlapping resources are indicated in more than one SCI format, and the HARQ state for a TB corresponding to at least one first SCI format is ACK, and/or the TB associated with the at least one first SCI format has been successfully received on the resource r₁ indicated in the first SCI format, in case that at least one other resource r₂ is also indicated in the first SCI format, the UE does not use the other resources r₂ in the conflict determining process, but may or may not use r₁ in the conflict determining process, and then determines whether a conflict occurs based on the method in Embodiment 1.

For example, if the UE detects that a conflict occurs among resources r₁, r₂, r₃ indicated in the first SCI, the second SCI, and the third SCI, respectively, and the UE is the destination UE of a TB transmitted on the resource r₁ or the destination UE of the first SCI format, and the HARQ feedback of the UE for the TB transmitted on the resource r₁ or the TB associated with the first SCI format is ACK, then the UE considers that only conflict occurring between the resources r₂, r₃ indicated in the second SCI and the third SCI respectively is detected.

For another example, if the UE detects that a conflict occurs among the resources r₁, r₂, r₃ indicated in the first SCI, the second SCI, and the third SCI respectively, and the UE is the destination UE of the first SCI format, and the HARQ feedback of the UE for the TB associated with the first SCI format and not transmitted on r₁(for example, it can be transmitted on other resource indicated in the first SCI) is ACK, then the UE considers that only conflict occurring the resources r₂ and r₃ indicated in the second SCI and the third SCI respectively is detected. The method can be used in the scenario where the first SCI format indicates multiple resources, in which the TB associated with the first SCI format is actually transmitted on one resource indicated by the first SCI format, and other resources indicated by the first SCI format can be considered as reserved for future potential retransmission of the TB. Therefore, when the TB is successfully received, the UE expects that potential retransmission will not occur in the future, and other resources indicated by the first SCI format are expected to be released by the UE, so it can be considered that they will not cause a conflict.

According to various embodiments of the present disclosure, a method is provided for UE to determine the inter-UE conflict, especially the conflict between more than two UEs, and to indicate the conflict through IUCI, so that UE can solve the impact on reliability caused by the conflict in wireless network, and the method is suitable for a wider application scenario instead of being limited to the application scenario of two UEs, and can more effectively improve the communication performance in complex and changeable radio environment.

### Embodiment 2

Embodiment 2 describes a method of sending IUCI for indicating a conflict based on the transmission situation of HARQ feedback information.

FIG. 6 is a flowchart according to embodiment 2 of the present disclosure.

Referring to FIG. 6, in S601, feedback is enabled and inter-UE coordination (IUC) indicating a conflict is enabled. In S602, feedback information and conflict indication information are transmitted on the feedback channel.

In the sidelink communication system with HARQ feedback enabled, after receiving the physical sidelink control channel (PSCCH)/physical sidelink shared channel (PSSCH), the UE may send feedback information including ACK or NACK to the sending UE on the physical sidelink feedback channel (PSFCH), depending on whether the reception is successful or not. The feedback information corresponds to the received SCI (carried in the PSCCH and PSSCH) or data (carried in the PSSCH), and the UE determines the resource location of the PSFCH used to send HARQ feedback according to the resource location of the SCI/PSCCH/PSSCH and the preset mapping rule.

In a sidelink communication system with inter-UE coordination (IUC) enabled, a typical method is that after receiving the physical sidelink control channel (PSCCH)/the physical sidelink shared channel (PSSCH), the UE may send inter-UE coordination information (IUCI) including a conflict indication to the sending UE on the PSFCH according to whether the resource indicated in SCI conflicts with other resource. The IUCI also corresponds to the received SCI, and the UE determines the resource position of the PSFCH used to send HARQ feedback according to the resource position of the SCI/PSCCH/PSSCH and the preset mapping rule.

Since HARQ feedback and IUCI including a conflict indication, as two kinds of mechanisms, are fed back on the PSFCH and triggered by the received SCI, the relationship between the both needs to be determined in the sidelink communication system, so that the UE which is configured to enable HARQ feedback and IUCI at the same time can send these two types of signaling. As there is an upper limit to the number of PSFCHs that a UE can send at the same time, which is affected by the UE capability, combining HARQ feedback and IUCI in the same signaling can effectively improve system performance.

In an exemplary embodiment, the UE is configured to (and supports to) enable HARQ feedback characteristics and IUC characteristics, and the enabled IUC characteristics include transmitting IUCI on the PSFCH, then when the UE sends HARQ feedback and IUCI for the received PSCCH/PSSCH, it uses at least one of the following methods to send HARQ information and IUCI:
multiplexing of HARQ feedback and IUCI;
bundling of HARQ feedback and IUCI; or
joint coding of HARQ feedback and IUCI.

Optionally, according to the UE capability/configuration/preset method, the UE may use at least one of the following:
at least one of the above methods is used only when the UE needs to send both HARQ feedback and IUCI. For example, when the UE is configured to only send NACK but not send ACK, if the HARQ feedback is ACK, the UE only sends IUCI, and the above method is not used; or when the UE is configured to send IUCI only when a conflict occurs, if there is no conflict, then the UE only sends the HARQ feedback, and the above method is not used;
the UE transmits the IUCI and the HARQ feedback using at least one of the above methods, regardless of the state of the HARQ feedback and the IUCI.

Optionally, the UE may multiplex HARQ feedback and IUCI in the same PSFCH, including: indicating information of a+b bits in the PSFCH, where a and b may be any positive integer, for example, a bits are used for the HARQ feedback and b bits are used for the IUCI. Optionally, a=1 and b=1; or, a=1, and b is at least one of the following: the maximum number of resources that can be indicated in an SCI format, the number of actually indicated resources in an SCI format, the maximum number of resources that may be indicated in an SCI format-p₁, and the number of actually indicated resources in an SCI format-p₂, where p₁ and p₂ are positive integers, for example, p₁ and p₂ can be 1. Wherein, the SCI includes SCI corresponding to the HARQ feedback and/or the ICUI.

Optionally, for b=1, the 1 bit is used to indicate two states: presence of a conflict and absence of a conflict. When a conflict occurs on at least one resource indicated in the received SCI format, the value of b is set to the state of presence of a conflict, otherwise, the value of b is set to the state of absence of a conflict. Optionally, only when the value of b is set to the state of presence of a conflict, the UE sends the IUCI multiplexed with the HARQ feedback, otherwise, the UE does not send the IUCI, but only determines whether to send the HARQ feedback that is not multiplexed with the IUCI according to the state and the configuration of the HARQ feedback.

Optionally, in case that b is the maximum number of resources that can be indicated in the SCI format or the number of resources actually indicated in the SCI format, each bit of the b bits corresponds to a resource indicated in the SCI format in sequence. Optionally, in case that b is the maximum number of resources that can be indicated in an SCI format-p₁ or the number of resources actually indicated in an SCI format-p₂, each bit in the b bits corresponds to a resource starting from the second resource or the (p₁+1)th resource or the (p₂+1)th resource indicated in the SCI in sequence, where p₁ and p₂ are positive integers, for example, p₁ and p₂ may be 1.

Optionally, the UE may bindle the HARQ feedback and the IUCI in the same PSFCH, including: indicating information of 1 bit in the PSFCH, the 1 bit is used to indicate two states, namely, a first state and a second state. The first state indicates a state including at least one of the four states: positive feedback and presence of a conflict, positive feedback and absence of a conflict, negative feedback and presence of a conflict, negative feedback and absence of a conflict, and the second state indicates at least one of the fourth state except the first state. For example, the first state is ACK feedback and absence of a conflict, and the second state includes at least one state of the four states except the first state, where the former state can be understood as not requiring retransmission, and the latter state can be understood as requiring retransmission and requiring resource reselection. For example, the first state is NACK and presence of a conflict, and the second state is NACK and absence of a conflict.

Optionally, the UE may jointly encode HARQ feedback and IUCI in the same PSFCH, including: indicating information of log₂(c*d) bits in the PSFCH, where c and d can be any positive integers, and c is the number of the states of the HARQ, for example, c=2, corresponding to two states of ACK and NACK, or c=1, corresponding to an NACK state (which can be used when the UE is configured to only send NACK but not send ACK); d is the number of the states of the IUCI, for example, d=2\hat{ }n, and n is at least one of the following: the maximum number of resources that can be indicated in SCI, the number of resources actually indicated in an SCI format, the maximum number of resources that can be indicated in SCI-1, and the number of resources actually indicated in an SCI format-1.

According to various embodiments of the present disclosure, a method of sending IUCI for indicating a conflict based on the transmission situation of HARQ feedback information is provided, so that the UE can send more information by combining the HARQ feedback information and the IUCI in the same signaling when the UE is limited by the UE capacity of the upper limit of the number of signaling that can be sent at the same time, thus more effectively improving the communication performance in complex and changeable radio environment.

### Embodiment 3

Embodiment 3 illustrates a method for determining signaling used to carry IUCI and determining content of the sent IUCI based on the used signaling when the UE can use multiple different signaling to send the IUCI for scheme 1. For example, the UE can choose the signaling used to carry the IUCI by itself, or it can obtain the signaling (pre)configured by the high-layer signaling for the UE to carry the IUCI, or it can use the preset signaling.

FIG. 7 is a flowchart according to embodiment 3 of the present disclosure.

Referring to FIG. 7, in S701, a signaling for carrying inter-UE coordination information (IUCI) is determined. At S702, based on the determined signaling, the IUCI is sent.

In the sidelink communication system, the IUCI of Scheme 1 can be sent through high-layer signaling and/or physical layer signaling, the typical high-layer signaling is MAC CE, and the typical physical layer signaling is SCI. The SCI has the advantages of smaller latency and more flexible transmission, but the disadvantage of the SCI is that its capacity is limited by the coding mechanism of polar code, and it can only accommodate limited (e.g. <=3) preferred/non-preferred resources compared with high-layer signaling, so it may fail to send all IUCI at one time. The advantage of the MAC CE includes larger capacity, moderate processing latency compared with other high-layer signaling, and sending/receiving IUCI by MAC CE and using the IUCI in the resource determination process are more compliant with the protocol structure in which the MAC layer triggers the physical layer to initiate the resource determination process and finally select the transmission resources. Therefore, two feasible methods of sending the IUCI are considered in the sidelink communication system: sending the IUCI only with the MAC CE, and sending the IUCI with the MAC CE and the SCI. For the latter method, it is necessary to further determine the relationship between the IUCI carried by the MAC CE and the IUCI carried by the SCI, so as to find out how the both are jointly used in the IUC mechanism.

In an exemplary embodiment, if the UE adopts MAC CE and SCI to send IUCI, then the UE indicates or carries different or partially different information in the MAC CE and the SCI. For example, x resources are indicated or carried in the MAC CE and the other y resources are indicated in the SCI, and x and y can be any positive integers.

Further, the different information may be based on the type of the IUCI and/or the time latency of the IUCI. For example, x₁ non-preferred resources are indicated in the MAC CE and y₁ preferred resources are indicated in the SCI, and x₁ and y₁ can be any positive integers.

For another example, the UE sends IUCI in the slot n, indicating or carrying in MAC CE x₂ resources of which time domain positions are not limited, and indicating or carrying in SCI y₂ resources of which time domain positions are limited, where x₂ and y₂ can be any positive integers, such as y₂ resources of which time domain positions are no earlier than n-_{proc,L2} and/or no later than n-T_{proc,L1}, n-T_{proc,L1}, T_{proc,L2} are the processing latency for UE receiving and using (including steps of decoding the IUCI, acquiring the content of the IUCI, using the content of the IUCI for UE's own transmission (including selecting transmission resource), etc.) the IUCI based on the SCI and the IUCI based on the MAC CE. The technical reason for the method in this embodiment is that, since the UE may not be able to modify the content in the MAC CE after selecting the transmission resource, the resources indicated or carried in the MAC CE do not need to be modified according to the selected IUCI transmission resource; however, the UE can generate SCI indicating or carrying the IUCI after selecting the transmission resource of the IUCI, so the UE can, based on the transmission resource position of the IUCI, indicate in the SCI some resources with earlier time domain positions, which cannot meet the MAC signaling processing latency, but can meet the PHY signaling processing latency, so that the IUCI acquired by the UE is affected by processing latency more slightly.

In addition, in the present embodiment, the MAC CE can also be replaced by other higher layer signaling, and the SCI can also be replaced by other physical layer signaling.

In an exemplary embodiment, the UE selects the type of signaling (e.g., MAC CE and/or SCI) for indicating IUCI based on at least one of the following conditions:
latency of the IUCI, including the remaining packet delay budget (PDB) corresponding to the IUCI or the latest time point of the time domain transmission position corresponding to the IUCI. For example, when the latency exceeds a threshold, the UE can use the MAC CE, otherwise it can only use the SCI; for example, the UE only uses MAC CE when the latency exceeds a first threshold, MAC CE and SCI when the latency is lower than the first threshold and exceeds a second threshold, and SCI when the latency is lower than the second threshold.
channel busy ratio (CBR), for example, the UE determines whether the SCI can be used and/or the MAC CE can be used, based on whether the measured CBR exceeds a threshold/falls within a specific threshold range. The motivation of the method is that when the CBR is high, that is, the radio interference is strong, the reliability of the SCI is worse, so the SCI may not be suitable to be signaling indicating IUCI.
service priority, the specific method is similar to the CBR. For example, the UE judges whether the SCI can be used and/or the MAC CE can be used, based on whether the service priority exceeds a threshold/whether it belongs to a specific threshold range. The motivation of the method is that when the service priority is higher, the service needs stricter reliability, and the reliability of the SCI is lower than that of the MAC CE, so the SCI may not be suitable to be signaling indicating IUCI in this scenario;
distance, for example, a physical distance, which can be determined based on the area ID of the destination UE of the IUCI. The specific method is similar to the CBR. For example, the UE determines whether the SCI can be used and/or the MAC CE can be used, based on whether the distance exceeds a threshold/falls within a specific threshold range. The motivation of the method is that when the distance is farther, the received power is lower or the channel is subject to more interference, and the reliability of the SCI is lower than that of the MAC CE, so the SCI may not be suitable to be signaling indicating IUCI in this scenario.

In an exemplary embodiment, when judging the validity of IUCI, the UE adopts different judging mechanisms for the IUCI indicated in the MAC CE and the IUCI indicated in the SCI. For example, different time thresholds are used to determine whether the IUCI is outdated or meets the requirement of processing latency, and different RSRP thresholds are used to determine whether the IUCI needs to be decoded.

In an exemplary embodiment, when the UE indicates at least one resource in the IUCI, the method of indicating the time domain position of the resource includes indicating the time domain offset of the resource or indicating information on the time domain resource based on a specific time domain reference point, such as a time resource indicator value (TRIV). The specific time domain reference point can be at least one of the following:
a time domain reference point explicitly indicated in a specific field of the MAC signaling or other high-layer signaling when the UE indicates the IUCI using the MAC signaling or other high-layer signaling;
a time point (such as a slot) at which physical layer signaling is sent when the UE uses the physical layer signaling (such as SCI) to indicate the IUCI.

Wherein, when UE supports retransmission of the IUCI, further, the specific time domain reference point may be at least one of the following:
for the retransmission of the IUCI, the time domain reference point reuses the time domain reference point of the first transmission;
for the retransmission of the IUCI, the time domain reference point is determined based on the retransmission at this time. For example, when the UE indicates the IUCI using the physical layer signaling (such as the SCI), it's the time point of the physical layer signaling when the retransmitted IUCI is sent.

In an exemplary embodiment, when the UE supports retransmission of the IUCI, the UE sends the IUCI using at least one of the following methods:
after the UE generates the IUCI indicated by the MAC CE, regardless of whether it is the first transmission or the retransmission, the IUCI content indicated in the MAC CE is not modified, that is, the MAC CEs of the first transmission and the retransmission are the same;
for the IUCI indicated by the SCI, the content of the IUCI can be modified at every time of transmission (including the first transmission/the retransmission). For example, the resources that have been outdated/do not meet the processing latency requirements in the IUCI content can be removed or new resources can be added.

In an exemplary embodiment, if the UE supports and is configured/preset to be able to multiplex the MAC CE indicating the IUCI with other MAC CE and/or MAC SDU, and also be able to include only the MAC CE indicating the IUCI in a MAC PDU, when the UE sends the IUCI, it is indicated in the SCI whether the associated PSSCH only includes the IUCI, and/or whether the content of the IUCI included in the PSSCH is the same as that indicated in the SCI. If so, the UE that receives the IUCI can only decode the SCI without decoding the PSSCH. The method can reduce the latency of UE receiving the IUCI, and avoid the overhead for repeatedly decoding the same IUCI in SCI and MAC CE twice by the UE.

According to the embodiment of the present disclosure, there is provided a method of selecting a more appropriate signaling to transmit the IUCI in connection with the information in the IUCI and the application scenarios, when the UE is configured/preset to be able to use various signaling to transmit the IUCI, thus perfecting the specific use mechanism of inter-UE coordination IUC characteristics, and improving the performance of the IUC characteristics through thy mechanism, such as higher reliability, lower latency, wider application scenarios, etc.

Embodiment 3 also illustrates a method of generating and sending IUCI when the UE can transmit the IUCI based on different conditions for Scheme 1.

In the sidelink communication system, the inter-UE coordination can be triggered not only by the received request signaling, but also by other conditions. The first UE may be configured to enable any one of the following methods:
Method 1: the first UE determines whether to trigger generation of the IUCI according to its own implementation;
Method 2: generation of the IUCI is triggered only when the first UE has data to be sent to the second UE together with the IUCI.

According to the above different conditions, the UE generates and sends the IUCI accordingly.

In an exemplary embodiment, when the first UE is configured to enable Method 2 and has data to be sent to the second UE, the first UE is triggered to generate and send the IUCI. In the present embodiment, the first UE determines the resources for sending the data based on sensing, and information indicated in the IUCI sent by the first UE may be based on at least one of the following:
explicitly indicating the starting and/or ending position of the time range of the indicated preferred resources and/or non-preferred resources in the IUCI by the first UE, where the starting and/or ending position may be determined by the UE based on its own implementation;
taking the starting and/or ending position of a resource selection window RSW(resource selection window) as the starting and/or ending position of the time range of the indicated preferred resources and/or non-preferred resources;
taking the starting and/or ending position in the next period corresponding to the RSW as the starting and/or ending position of the time range of the indicated preferred resources and/or non-preferred resources. Specifically, if the RSW is denoted as [n+T1, n+T2], the starting and/or ending position in the next period corresponding to the RSW is [n+T1+Pᵣₛᵥₚ, n+T2+Pᵣₛᵥₚ], where Pᵣₛᵥₚ is the resource reservation period corresponding to the data (that is, P_{rsvp_Tx} indicated by the higher layer during the resource determination process of the first UE for transmitting the data), or Pᵣₛᵥₚ is all values or a subset of the all values in resource reserve period (that is, the resource reserve period indicated in the high-layer parameter sl-ResourceReservePeriodList) configured in the resource pool sending the data. When there are many available Pᵣₛᵥₚ values, the first UE explicitly indicates the value of the used Pᵣₛᵥₚ in the IUCI, or considers that the starting and/or ending position of the RSW has multiple groups of positions, which correspond to the multiple values of the available Pᵣₛᵥₚ;
indicating preferred and/or non-preferred resource in the form of a bitmap.

The information indicated in the IUCI sent by the first UE may also be based on at least one of the following:
taking the excluded resources determined in the resource determination process as non-preferred resources, where, for example, for the resource determination process, the description in Section 8.1.4 of the standard TS 38.214 can be referred to. Optionally, the excluded resources are excluded resources in the RSW;
taking the non-excluded resources determined in the resource determination process as preferred resources;
taking the resources in the subsequent period corresponding to the excluded resources determined in the resource determination process as the non-preferred resources. Specifically, if for any resource r1 excluded in step 5) and/or 6) of the resource determination process, the slot in which r1 is located is denoted as t1, and the sub-channel used by r1 is denoted as [f1, f2], then the reserved resource in the subsequent period corresponding to r1 is the sub-channel [f1, f2] on the slot t1+Pᵣₛᵥₚ. Wherein, if the resource r1 excluded in step 5) and/or 6) is a slot, [f1, f2] corresponds to all channels in the resource pool, that is, the reserved resource in the subsequent period corresponding to r1 is slot t1+Pᵣₛᵥₚ. Optionally, the resource reserved in the subsequent period corresponding to the resources excluded in step 5) is a slot, and the resources reserved in the subsequent period corresponding to the resource excluded in step 6) are several sub-channels in a slot;
taking the resources in the subsequent period corresponding to the non-excluded resources determined in the resource determination process as the preferred resources. The specific method is similar to taking the resources in the subsequent period corresponding to the excluded resources determined in the resource determination process as non-preferred resources;
taking the resources used for the transmission and/or the subsequent transmission of the first UE determined in the resource determination process as non-preferred resources. Specifically, if the first UE (physical layer or higher layer) selects N resources in the current transmission period for the data transmission, and possibly also selects M resources in the subsequent transmission period for the data transmission, then the first UE takes these M+N resources as non-preferred resources. Optionally, the N resources in the current transmission period include at most 3 PSSCH resources indicated in the SCI format associated with the data. Optionally, the M resources in the subsequent transmission period include the subchannels [f1ᵢ, f2ᵢ] on the slot tᵢ+Pᵣₛᵥₚ, and tᵢ, f1ᵢ, f2ᵢ correspond to the time-frequency positions of the ith PSSCH resource indicated in the SCI format associated with the data;
indicating the preferred and/or non-preferred resources in the form of time resource indicator value (TRIV) and/or frequency resource indicator value (FRIV) and/or the index of the starting/ending position of subchannels and the number of subchannels.

The methods according to various embodiments described in the claims or the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a RAM and a flash memory, a ROM, an electrically erasable programmable read only memory (EEPROM), a magnetic disc storage device, a CDROM, DVDs, other type optical storage devices, or a magnetic cassette. Alternatively, any combination of some or all of the memory devices may form a memory in which the program is stored. Further, a plurality of such memories may be included in the electronic device.

In addition, the programs may be stored in an attachable storage device which may access the electronic device through communication networks such as the Internet, Intranet, a local area network (LAN), a wide LAN (WLAN), and a storage area network (SAN) or a combination thereof. Such a storage device may access the electronic device via an external port. Further, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings have been presented to easily explain the technical contents of the disclosure and help understanding of the disclosure, and are not intended to limit the scope of the disclosure. That is, it will be apparent to those skilled in the art that other modifications and changes may be made thereto on the basis of the technical idea of the disclosure. Further, the above respective embodiments may be employed in combination, as necessary. For example, one embodiment of the disclosure may be partially combined with other embodiments to operate a BS and a terminal.

In the drawings in which methods of the disclosure are described, the order of the description does not always correspond to the order in which steps of each method are performed, and the order or relationship between the steps may be changed or the steps may be performed in parallel. Alternatively, in the drawings in which methods of the disclosure are described, some elements may be omitted and only some elements may be included therein without departing from the essential spirit and scope of the disclosure.

While the present disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

1. A method performed by a communication device in a communication system, the method comprising:
receiving multiple sidelink control information (SCI) from other communication devices; and
in case that the multiple SCI indicate the same or partially overlapping resource, determining whether a conflict occurs on resources indicated by the multiple SCI, based on at least one of information about relationship between the communication device and the multiple SCI, received power information related to the multiple SCI, and information about priorities indicated by the multiple SCI.

2. The method according to claim 1, further comprising:
sorting the multiple SCI; and
in order of the sorted multiple SCI, determining at least one of whether the same or partially overlapping resource is indicated by the multiple SCI or whether the conflict occurs on the resources indicated by the multiple SCI.

3. The method according to claim 2, wherein determining whether the same or partially overlapping resource is indicated by the multiple SCI comprises at least one of:
for resources indicated by any two SCI in the multiple SCI, determining whether the resources indicated by the any two SCI are the same or partially overlaps;
for a resource indicated by any one SCI in the multiple SCI, determining whether the resource indicated by the any one SCI is the same as or partially overlaps with resources indicated by at least one of all remaining SCI; or
for any one resource in a predetermined resource set, determining whether there are at least two resources including the any one resource among the resources indicated by the multiple SCI.

4. The method according to claim 3,
wherein determining whether the resources indicated by the any two SCI are the same or partially overlaps comprises: selecting the any two SCI in a configured or predetermined order,
wherein determining whether the resource indicated by the any one SCI is the same as or partially overlaps with the resources indicated by the at least one of the all remaining SCI further comprises: selecting the any one SCI in a configured or predetermined order, and
wherein the order is based on at least one of: a priority indicated by the SCI, a reference signal received power of the SCI, and information related to the same or partially overlapping resource in a time domain or a frequency domain.

5. The method according to claim 1, further comprising:
in case that the conflict occurs, determining whether to send a conflict indication to other SCI in a set of SCI in which the conflict occurs except the SCI with the highest priority, or determining whether to send a conflict indication to a communication device, from which other SCI except the SCI with the highest priority in a set of SCI comes, the set is a set of SCI in which the conflict occurs.

6. The method according to claim 5, further comprising:
after determining that the conflict indication is sent to the SCI or the communication device, when the communication device continues to determine whether the conflict occurs on the resources indicated by the multiple SCI, removing the determined SCI to which the conflict indication is sent from the received multiple SCI, or removing the determined communication device to which the conflict indication is sent from the communication devices from which the multiple SCI come, or removing the resource on which the conflict is determined to occur from the resources indicated by the multiple SCI.

7. The method according to claim 2, wherein sorting the SCI comprises:
sorting the multiple SCI based on at least one of the information about the relationship between the communication device and the multiple SCI, the received power information related to the multiple SCI, and the information about priorities indicated by the multiple SCI.

8. The method according to claim 1, further comprising:
in case that the conflict occurs on the resources indicated by the multiple SCI, determining whether to send a conflict indication and/or a resources corresponding to the conflict indication based on at least one of information about relationship between SCI related to the conflict and the communication device, information about whether data transmitted on the resource indicated by the SCI related to the conflict is successfully received by the communication device, and hybrid automatic repeat request (HARQ) information about data associated with the SCI related to the conflict.

9. The method according to claim 1, wherein determining whether the conflict occurs on the resources indicated by the multiple SCI is further based on at least one of:
whether the multiple SCI indicate the same or partially overlapping resources,
whether hybrid automatic repeat request (HARQ) information of data transmission corresponding to the multiple SCI is an acknowledgement (ACK), or
whether data associated with the multiple SCI is successfully received.

10. A method performed by a communication device in a communication system, the method comprising:
enabling feedback and enabling inter-UE coordination (IUC) indicating a conflict; and
transmitting feedback information and conflict indication information on a feedback channel.

11. The method according to claim 10, further comprising:
in case that both the feedback information and the conflict indication information are transmitted on the feedback channel, using at least one of the following methods:
multiplexing the feedback information and the conflict indication information;
bundling the feedback information and the conflict indication information; or
jointly coding the feedback information and the conflict indication information.

12. The method according to claim 11, further comprising:
in case that the feedback information and the conflict indication information are multiplexed, multiplexing the feedback information and the conflict indication information in the same feedback channel,
wherein information of a+b bits is indicated in the feedback channel, a and b are any positive integer,
wherein a bits are used for the feedback information, b bits are used for the conflict indication information,
wherein b includes at least one of the following: the maximum number of resources that can be indicated in the sidelink control information (SCI), the number of resources actually indicated in the SCI, the maximum number of resources indicated in the SCI-p₁, and the number of resources indicated in the SCI-p₂, where p₁ and p₂ are positive integers,
wherein the SCI includes SCI corresponding to at least one of the feedback information or the conflict indication information.

13. A method performed by a communication device in a communication system, the method comprising:
determining a signaling for carrying inter-UE coordination information (IUCI);
based on the determined signaling, sending the IUCI.

14. The method of claim 13, wherein determining the signaling for carrying the IUCI comprises: selecting the signaling for carrying the IUCI based on at least one of a latency of the IUCI, a channel busy ratio (CBR), a service priority, and a distance.

15. The method according to claim 13,
wherein determining the signaling for carrying the IUCI includes:
selecting the higher layer signaling and the physical layer signaling to carry the IUCI, and
wherein based on the determined signaling, sending the IUCI includes:
carrying different parts of the IUCI in the higher layer signaling and the physical layer signaling based on a type of the IUCI or a latency of the IUCI.
